(19) United States
(12) Patent Application Publication
(10) Pub. No.: US 2021/0211760 A1
(43) Pub. Date: Jul. 8, 2021

(54) DISPLAY DEVICE AND OPERATION METHOD THEREFOR

(71) Applicant: SAMSUNG ELECTRONICS CO., LTD., Suwon-si (KR)

(72) Inventor: Jeong-youb KIM, Seoul (KR)

(73) Assignee: SAMSUNG ELECTRONICS CO., LTD, Suwon-si (KR)

(21) Appl. No.: 15/998,940

(22) PCT Filed: Oct. 20, 2016
(86) PCT No.: PCT/KR2016/011819

§ 371 Date: Aug. 17, 2018

(30) Foreign Application Priority Data
Feb. 17, 2016 (KR) 10-2016-0018552

(51) Int. Cl. H04N 21/41; H04M 1/72412; H04N 21/422; H02J 50/10; B60W 50/00; H04N 21/478

(52) U.S. Cl. CPC H04N 21/41265; H04M 1/72412; H04N 21/42222; B60W 2050/0064; H02J 50/10; B60W 50/00; H04N 21/478; H04N 21/42203

(57) ABSTRACT

Provided is a display apparatus including a display unit, a communicator configured to sense contact of an electronic device and to communicate with the electronic device; and a controller configured to sense a function associated with the electronic device, to display a user interface (UI) on the display unit for manipulating the sensed function, and to receive, from the control device, a user input for manipulating the function with respect to the UI.

### TECHNICAL FIELD

The present disclosure relates to a display apparatus and an operation method therefor, and more particularly, to a display apparatus capable of using functions of an electronic device in contact with the display apparatus and an operating method thereof.

### BACKGROUND ART

A display apparatus is an apparatus having a function of displaying images a viewer may watch. For example, in the past, a television (TV) device, which is an example of a display apparatus, only performed a function of displaying broadcast images by receiving broadcast signals sent only from a broadcast station in a single direction. However, recently, a display apparatus provides various functions, in addition to the function of displaying broadcast images transmitted from a broadcast station. Also, a technique for the display apparatus to link with peripheral devices has been developed.

### DESCRIPTION OF EMBODIMENTS

### Technical Problem

Provided are a display apparatus capable of utilizing functions of an electronic device in contact with the display apparatus and a method of operating the display apparatus.

### Solution to Problem

According to an aspect of the present disclosure, a display apparatus includes: a display unit; a communicator configured to sense contact of an electronic device and to communicate with the electronic device; and a controller configured to sense a function associated with the electronic device, to display a user interface (UI) on the display unit for manipulating the sensed function, and to receive, from the control device, a user input for manipulating the function with respect to the UI.

### Advantageous Effects of Disclosure

According to the present disclosure, functions of an electronic device in contact with an apparatus according to the present disclosure may be used.

### BRIEF DESCRIPTION OF DRAWINGS

FIG. 1 is a diagram illustrating a display apparatus and an electronic device according to one or more embodiments.

FIG. 2 shows an example in which a display apparatus according to one or more embodiments senses a phone-call function of an electronic device.

FIG. 3 shows another example in which a display apparatus according to one or more embodiments senses a phone-call function of an electronic device.

FIG. 4 is a flowchart illustrating a method of operating a display apparatus, an electronic device, and a control device performing a phone-call function, according to one or more embodiments.

FIG. 5 shows an example in which a display apparatus according to one or more embodiments senses a messenger function of an electronic device.

FIG. 6 is a flowchart illustrating a method of operating a display apparatus, an electronic device, and a control device performing a phone-call function, according to one or more embodiments.

FIG. 7 shows an example in which a display apparatus according to one or more embodiments recognizes a wireless charging function of an electronic device.

FIG. 8 shows another example in which a display apparatus according to one or more embodiments senses a wireless charging function of an electronic device.

FIG. 9 shows an example in which a display apparatus according to one or more embodiments senses a remote control function of an electronic device.

FIG. 10 is a diagram for describing a display apparatus and a smart key, according to one or more embodiments.

FIG. 11 shows an example in which a display apparatus according to one or more embodiments includes a touch pad.

FIG. 12 shows an example in which a display apparatus according to one or more embodiments includes a touch pad and a light-emitting device.

FIG. 13 illustrates a display apparatus according to one or more embodiments determining a location of displaying a user interface (UI) on a screen according to a location of an electronic device.

FIG. 14 illustrates a display apparatus according to one or more embodiments selecting one of functions associated with an electronic device according to an orientation of the electronic device.

FIG. 15 illustrates a display apparatus according to one or more embodiments Selecting an icon included in a UI, based on a degree of locational variation of an electronic device.

FIG. 16 shows an example in which a display apparatus according to one or more embodiments displays a UI on a screen.

FIG. 17 shows an example in which a display apparatus according to one or more embodiments displays a UI on a screen.

FIG. 18 shows an example in which a display apparatus according to one or more embodiments displays a UI on a screen.

FIG. 19 is a block diagram of a display apparatus according to one or more embodiments.

FIG. 20 is another block diagram of a display apparatus according to one or more embodiments.

FIG. 21 is a side view of a display apparatus according to one or more embodiments.

FIG. 22 is another block diagram of a display apparatus according to one or more embodiments.

FIG. 23 is a block diagram of an electronic device according to one or more embodiments.

FIG. 24 shows an example of a screen of an electronic device according to one or more embodiments.

FIG. 25 shows an example of a screen of an electronic device in a case where a security lock is set on an electronic device, according to one or more embodiments.

FIG. 26 is a block diagram of a control device according to one or more embodiments.

FIG. 27 is a flowchart illustrating a method of operating a display apparatus according to one or more embodiments.

### BEST MODE

The display apparatus may further include a sound output unit, wherein the function sensed by the controller may include a phone-call function of the electronic device, the controller may be further configured to output a first voice signal received from the electronic device to the sound output unit, and the user input received by the controller from the control device may include a second voice signal and the controller may be further configured to transmit the second voice signal to the electronic device.

The function sensed by the controller may include a messenger function of the electronic device, the UI displayed on the display unit may include a first message transmitted from the electronic device, and the user input received by the controller from the control device may include at least one of a second message and a voice signal corresponding to the second message, and the controller may be further configured to display the second message on the display unit.

The function sensed by the controller may include a remote control function allowing the electronic device to remotely control a controlled device, and the controller may be further configured to transmit a command for controlling the controlled device to the electronic device, based on the user input received from the control device.

The controller may sense that the electronic device is a smart key capable of controlling a vehicle, the UI displayed on the display unit may include information about the vehicle, and the controller may be further configured to transmit a control command based on the user input received from the control device to the vehicle.

The display apparatus may further include a wireless charger configured to provide the electronic device with electric power, wherein the communicator may include a near field communication (NFC) module configured to sense the contact of the electronic device, the NFC module may be arranged on an upper end portion of the display apparatus, and the wireless charger is arranged on the upper end portion to be adjacent to the NFC module.

The display apparatus may further include a touch pad arranged on the upper end portion to sense a touch input with respect to the UI displayed on the display unit, and the controller may be configured to manipulate the above function associated with electronic device based on the user input and the touch input.

The display apparatus may further include a plurality of light-emitting devices arranged adjacent to the touch pad, and when the UI displayed on the display unit includes a plurality of icons that a user may select, the controller may be configured to select light-emitting devices corresponding to locations of the plurality of icons, from among the plurality of light-emitting devices, to emit light from the selected light-emitting devices.

The controller may be further configured to obtain orientation information of the electronic device, and to determine a location of displaying the UI on the display unit or to select the sensed function, based on the orientation information.

When a security lock is set in the electronic device, the controller may be further configured to display a UI requesting to certify authority of using the electronic device on the display unit.

According to an aspect of the present disclosure, an operation method of a display apparatus, the operation method includes: sensing contact of an electronic device and communicating with the electronic device; sensing a function associated with the electronic device and displaying a user interface (UI) for manipulating the sensed function on a screen of the display apparatus; and receiving, from a control device, a user input for manipulating the function with respect to the UI.

The operation method may further include: when the sensed function includes a phone-call function of the electronic device, outputting a first voice signal transmitted from the electronic device; and when the user input transmitted from the control device includes a second voice signal, transmitting the second voice signal to the electronic device.

The sensed function may include a messenger function of the electronic device, the displayed UI may include a first message transmitted from the electronic device, and the user input transmitted from the control device may include at least one of a second message and a voice signal corresponding to the second message, and the method may further include displaying the second message.

The sensed function may include a remote control function allowing the electronic device to remotely control a controlled device, and the operation method may further include transmitting a command for controlling the controlled device to the electronic device based on the user input transmitted from the control device.

The operation method may further include: sensing that the electronic device is a smart key capable of controlling a vehicle; and transmitting, to the vehicle, a control command based on the user input transmitted from the control device, wherein the displayed UI includes information about the vehicle.

The operation method may further include: sensing a touch input with respect to the displayed UI via a touch pad arranged on an upper end portion of the display apparatus; and manipulating the function associated with the electronic device based on the user input and the touch input.

The operation method may further include, when the UI displayed on the display unit includes a plurality of icons that a user may select, selecting light-emitting devices corresponding to locations of the plurality of icons, from among the plurality of light-emitting devices, and emitting light from the selected light-emitting devices.

The operation method may further include: obtaining orientation information of the electronic device; and determining a location of displaying the UI on a screen of the display apparatus or selecting the sensed functions, based on the orientation information.

The operation method may further include, when a security lock is set in the electronic device, displaying a UI requesting to certify authority of using the electronic device on the display unit.

### MODE OF DISCLOSURE

Hereinafter, one or more embodiments of the present disclosure will be described in detail with reference to accompanying drawings to the extent that one of ordinary skill in the art would be able to carry out the present disclosure. However, the present disclosure may be implemented in various manners, and is not limited to one or more embodiments described herein. In addition, components irrelevant with the description are omitted in the drawings for clear description, and like reference numerals are used for similar components throughout the entire specification.

The terms used in the present disclosure are selected from among common terms that are currently widely used in consideration of their functions in the present disclosure, but the terms may be different according to an intention of one of ordinary skill in the art, a precedent, or the advent of new technology. Therefore, the terms used in the present disclosure are not merely designations of the terms, but the terms are defined based on the meaning of the terms and content throughout the present disclosure.

It will be understood that although the terms “first,” “second,” etc. may be used herein to describe various components, these components should not be limited by these terms. These components are only used to distinguish one component from another.

The terms used in the present specification are merely used to describe particular embodiments, and are not intended to limit the present disclosure. An expression used in the singular encompasses the expression of the plural, unless it has a clearly different meaning in the context. Throughout the specification, it will be understood that when an element is referred to as being “connected” to another element, it may be “directly connected” to the other element or “electrically connected” to the other element with intervening elements therebetween. It will be further understood that when a part “includes” or “comprises” an element, unless otherwise defined, the part may further include other elements, not excluding the other elements.

Throughout the specification, in particular, in claims, “the” or other similar referring expressions may refer to both a singular form and a plural form. Also, if there is no description explicitly referring to orders of operations included in methods according to the present disclosure, the operations may be performed in an appropriate order. The present disclosure is not limited to the described orders of operations.

Phrases such as “in some embodiments” or “in one embodiment” throughout the present specification may not necessarily denote the same elements.

Some embodiments of the present disclosure may be represented as functional block structures and various processing stages. Some or all of the functional blocks may be realized by any number of hardware and/or software components configured to perform the specified functions. For example, the functional blocks of the present disclosure may be realized by one or more microprocessors or circuit structures for performing a predetermined function. In addition, for example, the functional blocks of the present disclosure may be implemented with any programming or scripting language. The functional blocks may be implemented in algorithms that are executed on one or more processors. Also, the present disclosure may employ any number of conventional techniques for electronics configuration, signal processing and/or control, data processing and the like. The words “mechanism,” “element,” “means,” and “configuration” are used broadly and are not limited to mechanical or physical embodiments.

In addition, the connecting lines, or connectors shown in the various figures presented are intended to represent exemplary functional relationships and/or physical or logical couplings between the various elements. It should be noted that many alternative or additional functional relationships, physical connections or logical connections may be present in a practical device.

The present disclosure will be described in detail below with reference to accompanying drawings.

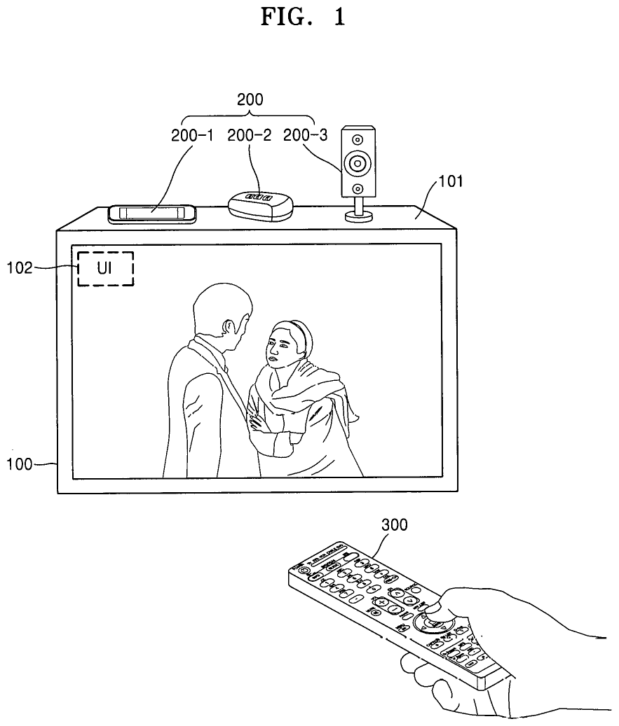

FIG. 1 is a diagram illustrating a display apparatus and an electronic device according to one or more embodiments.

Referring to FIG. 1, a display apparatus 100 may be an apparatus configured to output audio/video (A/V) content. The display apparatus 100 may output, in the A/V content, video content on a screen, and may output audio content via a sound output unit included in the display apparatus 100 or a speaker connected to the display apparatus 100. The speaker may be connected to the display apparatus 100 in various ways, e.g., by a wire, wireless, etc. For example, the speaker may include a wireless speaker, earphones, headphones, etc.

The A/V content may be real-time broadcasting content, or non real-time A/V content. For example, the non real-time A/V content may be A/V content provided as a video on demand (VOD) service. The display apparatus 100 may receive A/V content from an A/V content provider. The display apparatus 100 may receive the A/V content through streaming, or may download the A/V content. For example, the A/V content provider may be a broadcast service provider, a VOD service provider, etc.

The display apparatus 100 may receive broadcast signals and broadcast-related information from outside via a broadcast channel. The broadcast channel may include satellite channels and terrestrial channels. The display apparatus 100 may receive the A/V content through the broadcast channel or Internet. Alternatively, the display apparatus 100 may receive the A/V content from an external device connected thereto by wire or wireless. Alternatively, a memory included in the display apparatus 100 may store A/V content.

The display apparatus 100 may sense contact of an electronic device 200, and may communicate with the electronic device 200. The electronic device 200 may be placed on an upper end surface 101 of the display apparatus 100. The display apparatus 100 senses the contact of the electronic device 200 on the upper end surface 101 thereof, and then, may connect communication with the electronic device 200.

The electronic device 200 may include, for example, a smartphone 200-1, a smart key 200-2, a speaker 200-3, etc. However, FIG. 1 shows examples of the electronic device 200, and kinds or the number of the electronic devices 200 is not limited thereto. As another example, the electronic device 200 may include, but is not limited to, a tablet personal computer (PC), a personal digital assistant (PDA), a media player, a micro-server, a global positioning system (GPS) device, an electronic book terminal, a digital broadcasting terminal, a navigation device, a kiosk, an MP3 player, a digital camera, and other computing devices. The electronic device 200 may include any type of electronic device, provided that a communicator and a controller are included in the electronic device.

The display apparatus 100 may be in communication with the electronic device 200, while the electronic device 200 is placed on the upper end surface 101 thereof. When a user places the electronic device 200 on the upper end surface 101 of the display apparatus 100, the display apparatus 100 may be automatically connected to the electronic device 200. When the user removes the electronic device 200 from the upper end surface 101, the display apparatus 100 may be disconnected from the electronic device 200.

The display apparatus 100 may include a near field communication (NFC) module for sensing the contact of the electronic device 200. The NFC module may be arranged on an upper end portion of the display apparatus 100.

In FIG. 1, the electronic device 200 is in contact with the upper end surface 101 of the display apparatus 100, but a portion where the electronic device 200 contacts the display apparatus 100 is not limited to the upper end surface 101. The electronic device 200 may contact another portion of the display apparatus 100, e.g., a side surface of the display apparatus 100. Alternatively, the display apparatus 100 may sense the contact of the electronic device 200 only from a certain portion, by arranging the NFC module on the certain portion. The display apparatus 100 may have an indicator that indicates the certain portion at which the contact of the electronic device 200 may be sensed. The user may recognize the certain portion due to the indicator, and may easily put the electronic device 200 into contact with the certain portion. The indicator of the display apparatus 100 may be represented as a line, a groove, etc.

The display apparatus 100 may sense functions associated with the electronic device 200. For example, the functions associated with the electronic device 200 may include a phone-call function of the electronic device 200, a messenger function of the electronic device 200, a sound output function of the electronic device 200, a control function that the electronic device 200 may remotely control a controlled device, etc., that is, functions performed by the electronic device 200. In addition, the functions associated with the electronic device 200 may be various, that is, a function of transferring and receiving content to and from the electronic device 200, a function of communicating with the electronic device 200 such as a backup function, a function of wirelessly charging the electronic device 200, etc. However, the functions associated with the electronic device 200 are not limited to the above-described functions, and may include various functions by which the display apparatus 100 may be linked with the electronic device 200.

Also, the display apparatus 100 may sense at least one function associated with the electronic device 200. The display apparatus 100 may sense a plurality of functions associated with one electronic device 200.

The display apparatus 100 may display a user interface (UI) 102 for manipulating the sensed functions associated with the electronic device 200. The UI 102 is provided for interaction with the user, that is, allows the user to recognize the functions associated with the electronic device 200 sensed by the display apparatus 100 and to manipulate the associated functions. The UI 102 may include various pieces of information such as information about the electronic device 200, information about the functions associated with the electronic device 200, information generated when the display apparatus 100 performs the associated functions, etc. Also, the UI 102 may include a UI allowing the user to select, set, or control the functions associated with the electronic device 200.

When the display apparatus 100 senses the plurality of functions associated with the electronic device 200, the UI 102 may include a list of the plurality of functions and UIs by which each function may be selected, set, and manipulated. The UI 102 may be displayed on a screen in various ways, e.g., as a text, an image, a combination thereof, etc. The display apparatus 100 may further output a sound UI, in addition to the UI 102 displayed on the screen. The display apparatus 100 may output at least one of the UI 102 displayed on the screen and the sound UI. The display apparatus 100 may output the UI 102 in various ways so as to interact with the user. Hereinafter, the UI 102 displayed on the screen of the display apparatus 100 will be described for convenience of description, but this does not exclude the sound UI.

The display apparatus 100 may output the UI 102 for certifying authority of using the electronic device 200 or authority of controlling the functions associated with the electronic device 200. When the display apparatus 100 senses the contact of the electronic device 200, the display apparatus 100 may output the UI 102 requesting the certification of the authority for using the electronic device 200 or authority for controlling the functions associated with the electronic device 200. The user may input an identification (ID) of the electronic device 200, a password, a fingerprint, etc. via the control device 300.

The display apparatus 100 may request the certification of the usage authority or control authority when sensing the contact of the electronic device 200. The display apparatus 100 may request the certification of the usage authority or control authority whenever the display apparatus 100 senses the contact of the electronic device 200. Alternatively, the display apparatus 100 may request the certification of the usage authority or the control authority, only when sensing contact of the electronic device 200 that has not been certified before. That is, the display apparatus 100 may not request the certification of the usage authority or the control authority when sensing re-contact of the electronic device 200 that has been certified once before. The certification between the display apparatus 100 and the electronic device 200 may be implemented in various ways, and is not limited to the above examples.

The display apparatus 100 may receive, from the control device 300, a user input for manipulating the functions associated with the electronic device 200 with respect to the UI 102. The control device 300 may remotely control the display apparatus 100. The user may recognize the functions associated with the display apparatus 100 via the UI 102 displayed on the display apparatus 100, and may input a user input to the control device 300 by pushing a button of the control device 300, etc. The control device 300 transfers the user input to the display apparatus 100, and the display apparatus 100 receiving the user input may perform the functions associated with the electronic device 200 based on the user input. The display apparatus 100 may perform communication with the electronic device 200 in order to perform the functions associated with the electronic device 200. In addition, the display apparatus 100 may perform the associated functions, linking with the electronic device 200.

In addition to the control of the UI 102 via the control device 300, the display apparatus 100 may be variously controlled by using the control device 300, for example, turning on/off the display apparatus 100, switching channels, adjusting volume, selecting a kind of broadcasting, e.g., terrestrial channel/cable channel/satellite channel, setting environment of the display apparatus 100, etc.

The control device 300 may include, but is not limited to, a TV remote controller, a pointing remote controller, a mouse, a motion recognizer, etc. The control device 300 shown in FIG. 1 is an example, and any kind of control device capable of controlling the display apparatus 100 may be used as the control device 300.

The display apparatus 100 may obtain the user input for manipulating the functions associated with the electronic device 200 with respect to the UI 102, in various ways rather than using of the control device 300. For example, a microphone included in the display apparatus 100 receives a sound signal such as voice of the user, and the display apparatus 100 may obtain the sound signal as a user input. A camera included in the display apparatus 100 senses a motion gesture of the user, and the display apparatus 100 may obtain the motion gesture as a user input. The display apparatus 100 may receive a user input via a touch screen implemented on the screen of the display apparatus 100 or a touch pad provided on an outer portion of the screen of the display apparatus 100.

The display apparatus 100 may output audio/video (A/V) content. The display apparatus 100 outputting the A/V content may output the UI 102 together with the A/V content. The display apparatus 100 may output the UI 102 with video content of the A/V content that is being output on the screen. In a case where the display apparatus 100 outputs a sound UI, the display apparatus 100 may restrict outputting of audio content of the A/V content in order to output the sound UI. For example, the display apparatus 100 may reduce or mute the volume of the audio content, and then, output the sound UI.

Alternatively, the display apparatus 100 may output the UI 102 regardless of whether the A/Vcontent is being output. For example, the display apparatus 100 may output the UI 102 on a standby mode screen. Alternatively, the screen of the display apparatus 100 may be in a turn-off state, and then, when the display apparatus 100 senses the contact of the electronic device 200 or determines to output the UI 102, the display apparatus 100 may switch the screen from the turn-off state to a turn-on state and may output the UI 102 on the screen.

The user may manipulate the associated functions via the display apparatus 100 and the control device 300, without approaching the display apparatus 100 and picking up the electronic device 200 in order to manipulate the functions associated with the electronic device 200. In particular, when the user is watching the A/V content via the display apparatus 100, the user may manipulate the functions associated with the electronic device 200 via the control device 300 while watching the A/V content. Therefore, user's convenience may be greatly improved.

As an example, the display apparatus 100 may sense contact of the speaker 200-3, and may automatically connect communication with the speaker 200-3. The display apparatus 100 may sense a sound output function of the speaker 200-3 as a function associated with the speaker 200-3. If there is audio content to be output, the display apparatus 100 may transmit the audio content to the speaker 200-3 to make the speaker 200-3 output the audio content.

The display apparatus 100 may sense the sound output function of the speaker 200-3, and may display the UI 102 for manipulating the sound output function. The UI 102 may be for controlling the speaker 200-3, for example, displaying information about the sound output function and information about the speaker 200-3, representing whether to be connected to the speaker 200-3, adjusting the volume of the speaker 200-3, etc. However, the UI 102 is not limited to the above-described example, and the display apparatus 100 may display the UI 102 in various ways, provided that interaction with the user may be performed.

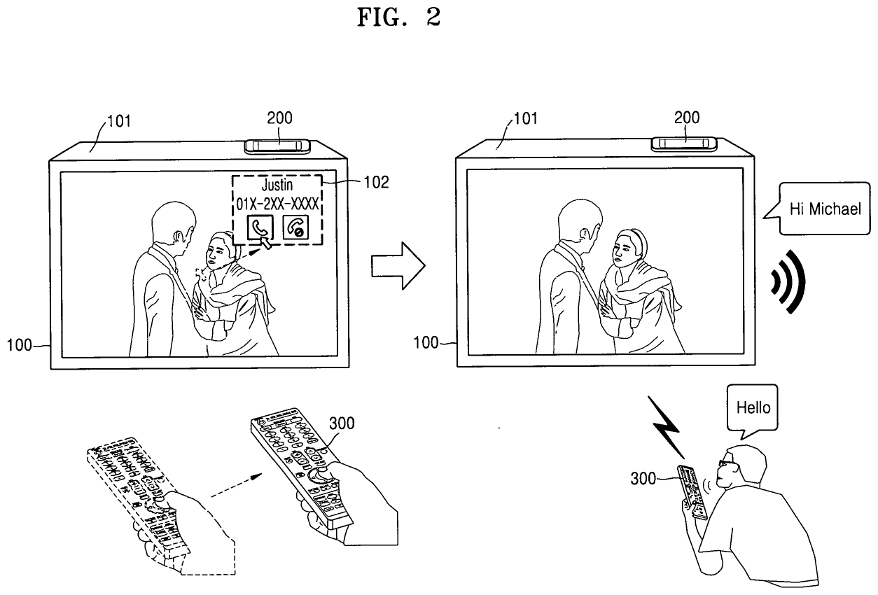

FIG. 2 shows an example in which a display apparatus according to one or more embodiments senses a phone-call function of an electronic device.

Referring to FIG. 2, the display apparatus 100 may sense contact of the electronic device 200. The display apparatus 100 may sense a function associated with the electronic device 200, and the function may include a phone-call function of the electronic device 200. The display apparatus 100 may perform the sensed function, that is, the phone-call function. In order to perform the phone-call function, the display apparatus 100 may communicate with the electronic device 200, and may be linked with the electronic device 200.

When the electronic device 200 receives a request for phone-call from an external device, the display apparatus 100 may display the UI 102 for manipulating the phone-call function on the screen. The UI 102 may display information about the phone-call request or may select whether to accept the phone-call request. The display apparatus 100 may output a sound UI, instead of the UI 102 displayed on the screen, or may further output a sound UI in addition to the UI 102. In FIG. 2, the UI 102 notifies the user of a phone-call request from a certain person and includes icons for accepting or refusing the phone-call request, but implementation of the UI 102 is not limited to the example of the UI 102 shown in FIG. 2.

The user may recognize that there is a phone-call request via the UI 102, and may input a user input for manipulating the phone-call function via the control device 300. The user may accept or refuse the phone-call request via the control device 300. In FIG. 2, it is assumed that the control device 300 has a pointing function. The display apparatus 100 may display a pointer of the control device 300 on the screen. The user may move the control device 300 for locating the pointer of the display apparatus 300 on the icon for accepting the phone-call request of the UI 102, and may select the icon for accepting the phone-call request by using the control device 300. The display apparatus 100 may receive, from the control device 300, a user input for accepting the phone-call request. FIG. 2 only shows an example of the user input for controlling the phone-call function, and a way that the display apparatus 100 receives the user input from the control device 300 may be variously implemented.

When receiving the user input for accepting the phone-call request, the display apparatus 100 may communicate with the electronic device 200 to perform the phone-call function.

The display apparatus 100 may output a voice signal corresponding to “Hi Michael” received from an external device that is call-connected with the electronic device 200, via a sound output unit included in the display apparatus 100 or a speaker connected to the display apparatus 100.

When the user says “Hello”, a microphone included in the control device 300 senses “Hello” and obtain a voice signal corresponding to “hello”. The control device 300 may transmit the voice signal to the display apparatus 100. The display apparatus 100 transmits to the electronic device 200 the voice signal corresponding to “hello” received from the control device 300, and makes the electronic device 200 transmit the voice signal corresponding to “hello” to the external device calling the electronic device 200.

The user may connect the phone-call to the external device calling the electronic device 200, via the microphone included in the control device 300, and the sound output unit included in the display apparatus 100 or the speaker connected to the display apparatus 100. The user may answer the phone via the display apparatus 100 and the control device 300 without approaching the display apparatus 100 to pick up the electronic device 200 to answer the phone. Therefore, user's convenience may be greatly improved.

The display apparatus 100 may output A/V content. In a case where the display apparatus 100 outputs a sound UI, the display apparatus 100 may restrict outputting of audio content of the A/V content in order to output the sound UI. For example, the display apparatus 100 may reduce or mute the volume of the audio content, and then, output the sound UI. Also, when the electronic device 200 is connected to a caller, the display apparatus 100 may restrict output of the A/V content that is being output. Since audio content in the A/V content may interfere with the phone call, the display apparatus 100 may restrict the audio content from being output during the call-connection of the electronic device 200.

FIG. 2 shows a case where the electronic device 200 receives a request for phone-call from an external device, but the user may also use the display apparatus 100 and the control device 300 for making a phone call. The user may transfer a user input for making a call to the display apparatus 100 via the control device 300, without approaching the display apparatus 100 and picking up the electronic device 200 for making a call. The display apparatus 100 may output a UI for allowing the user to send a request for phone-call to the external device. When a call is connected between the electronic device 200 and the external device, the user may talk to the external device via the display apparatus 100 and the control device 300.

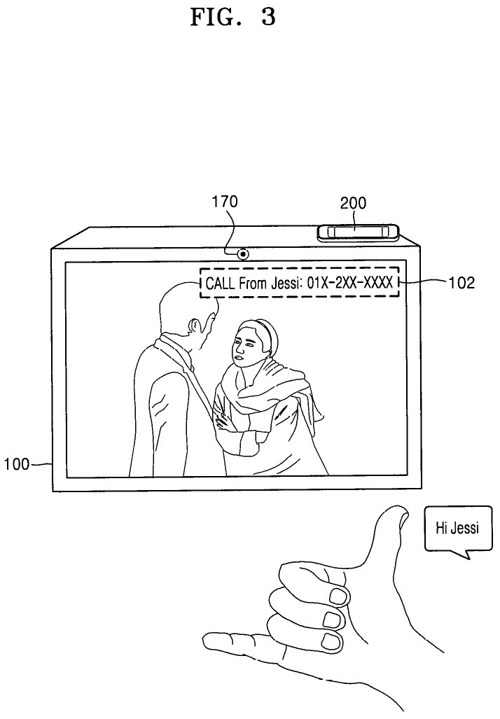

FIG. 3 shows another example in which a display apparatus according to one or more embodiments senses a phone-call function of an electronic device.

Referring to FIG. 3, when the electronic device 200 receives a request for a phone-call from an external device, the display apparatus 100 may display the UI 102 for displaying information about the request on the screen.

The display apparatus 100 may include a camera 170, and may sense a motion gesture of the user via the camera 170. The camera 170 may obtain image data such as a still image or a video of the user. The display apparatus 100 may sense the motion gesture by analyzing the image data obtained by the camera 170. The display apparatus 100 may determine whether to accept the request for phone-call based on the sensed motion gesture. A motion gesture for accepting the request for phone-call and a motion gesture for refusing the request for phone-call may be determined in advance. The display apparatus 100 may determine whether to accept the request for phone-call by comparing the sensed motion gesture with the motion gesture determined in advance. For example, a motion gesture that only a thumb and a little finger among five fingers of the user are unfolded may be determined in advance as the motion gesture for accepting the request for phone-call. When the display apparatus 100 senses the motion gesture, the display apparatus 100 may determine the sensed motion gesture to accept the request for phone-call. However, FIG. 3 only shows an example of the motion gesture, and the motion gesture is not limited to the example of FIG. 3.

When receiving a voice signal from the external device that is call-connected with the electronic device 200, the display apparatus 100 may output the received voice signal via the sound output unit included in the display apparatus 100 or the speaker connected to the display apparatus 100.

When the user says “Hi Jessi”, a microphone of a control device around the user or a microphone included in the display apparatus 100 senses “Hi Jessi” and may obtain corresponding voice signal. The display apparatus 100 may transmit the obtained voice signal to the electronic device 200 to make the electronic device 200 transmit the voice signal to the external device calling the electronic device 200.

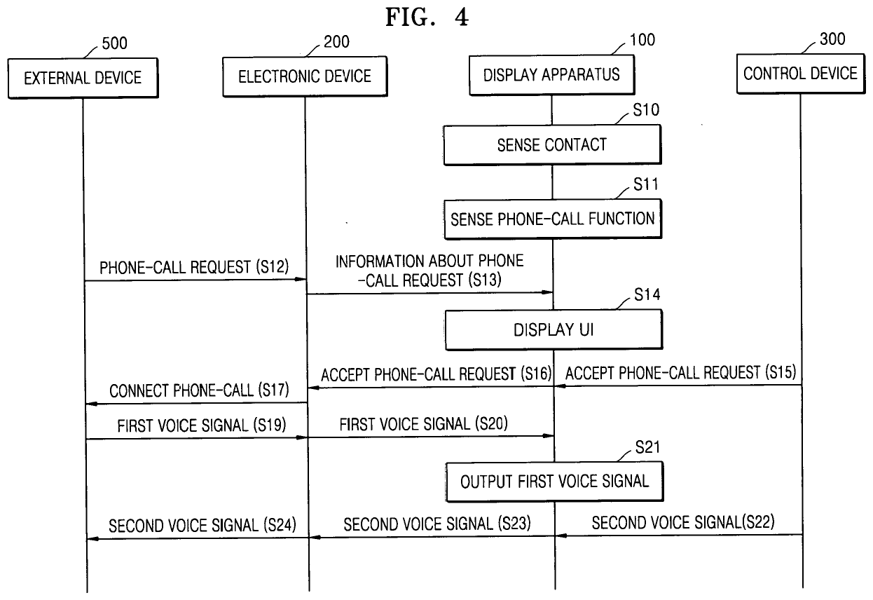

FIG. 4 is a flowchart illustrating a method of operating a display apparatus, an electronic device, and a control device performing a phone-call function, according to one or more embodiments.

Referring to FIG. 4, the display apparatus 100 may sense contact of the electronic device 200 (S10). The display apparatus 100 may sense a phone-call function of the electronic device 200 (S11).

When the electronic device 200 receives a request for phone-call from an external device 500 (S12), the electronic device 200 may transmit information about the request for phone-call to the display apparatus 100 (S13). The information about the request for phone-call may include information about the external device sending the request for phone-call, e.g., name, phone number of a caller, etc.

The display apparatus 100 may display a UI about the request for phone-call on the screen (S14). The UI regarding the request for phone-call may allow the user to recognize the request for phone-call or to manipulate the request for phone-call. The UI may be displayed on a screen in various ways, e.g., as a text, an image, a combination thereof, etc. Alternatively, the display apparatus 100 may output a sound UI instead of the UI displayed on the screen, or may output the sound UI with the UI displayed on the screen.

After S13, the display apparatus 100 may transmit a control signal for performing the phone call function to the control device 300. The control device 300 receiving the control signal may perform operations related to the performance of phone call function. For example, when the control device 300 operates in one of a plurality of modes including a control mode for controlling the display apparatus 100 and a phone call function performing mode, the control device 300 receiving the control signal may operate in the phone call function performing mode. Alternatively, the control device 300 receiving the control signal may activate the microphone of the control device 300. Alternatively, the control device 300 may flicker a light-emitting diode (LED) module of the control device 300. The user may recognize that the control device 300 may perform the operations associated with the performance of the phone call function, through the flickering of the LED module in the control device 300 and the UI output by the display apparatus 100.

When the display apparatus 100 may sense the motion gesture of the user and determine whether to accept the request for phone-call as shown in FIG. 3, the display apparatus 100 may activate the camera 170 (see FIG. 3) that may sense the motion gesture.

The display apparatus 100 may receive a user input for accepting the request for phone-call from the control device 300 (S15). Alternatively, when the display apparatus 100 may determine whether to accept the request for phone-call by sensing the motion gesture of the user as shown in FIG. 3, the display apparatus 100 may sense the motion gesture of the user, instead of receiving the user input from the control device 300, to determine whether to accept the request for phone-call based on the sensed motion gesture.

The display apparatus 100 transmits acceptance to the electronic device 200 (S16), to allow the electronic device 200 to connect the call with the caller. The electronic device 200 may connect the call with the external device 500 that requests the phone call (S17).

Unlike in S15 to S17, when the display apparatus 100 receives from the control device 300 a user input for refusing the request for phone-call or determines to refuse the request based on the sensed motion gesture, the display apparatus 100 may transmit a refusal to the electronic device 200 and the electronic device 200 may not connect the call with the external device 500 that has requested the call.

When the electronic device 200 receives a first voice signal from the external device 500 connected thereto (S19), the electronic device 200 transmits the first voice signal to the display apparatus 100 (S20), and the display apparatus 100 may output the first voice signal via the sound output unit included in the display apparatus 100 or a speaker connected to the display apparatus 100 (S21).

The control device 300 may transmit a second voice signal obtained through a user input to the display apparatus 100 (S22). The display apparatus 100 transmits the second voice signal transmitted from the control device 300 (S23), and thus, the electronic device 200 may transmit the second voice signal to the external device 500 (S24).

Alternatively, instead of receiving the second voice signal from the control device 300, the display apparatus 100 may obtain the second voice signal in other various ways. For example, the second voice signal may be obtained through the microphone of the display apparatus 100, and a microphone included in a device capable of transmitting signals by wires or wireless to the display apparatus 100. For example, the microphone may be included in a speaker connected to the display apparatus 100, e.g., earphones and headphones.

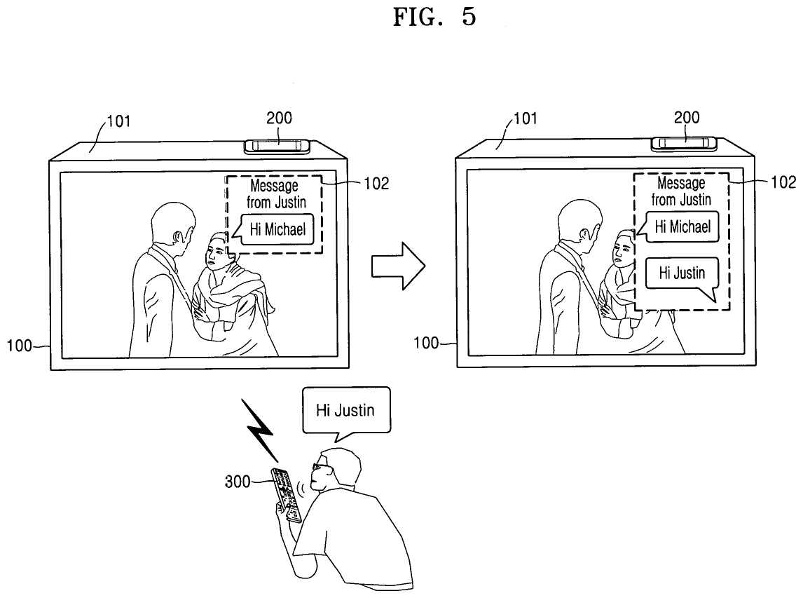

FIG. 5 shows an example in which a display apparatus according to one or more embodiments recognizes a messenger function of an electronic device.

Referring to FIG. 5, the display apparatus 100 may sense contact of the electronic device 200. The display apparatus 100 senses functions associated with the electronic device 200, and the sensed functions may include a messenger function of the electronic device 200. The display apparatus 100 may perform the sensed function, that is, the messenger function. In order to perform the messenger function, the display apparatus 100 may communicate with the electronic device 200, and may be linked with the electronic device 200.

When the electronic device 200 receives a first message (“Hi Michael”) from an external device, the electronic device 200 may transfer information about the external device, the first message (“Hi Michael”), etc. to the display apparatus 100.

The display apparatus 100 may display the UI 102 on the screen for manipulating the messenger function. The UI 102 may include information about the external device sending the message (e.g., name of a person, phone number, etc.) or the message (“Hi Michael”) received from the external device. The UI 102 may be provided for selecting whether to read the received message. FIG. 5 shows an example of the UI 102, and the UI 102 is not limited to the example of FIG. 5.

The control device 300 may receive an input of a second message (“Hi Justin”) from the user, and may transmit the second message (“Hi Justin”) to the display apparatus 100. The display apparatus 100 may display the second message (“Hi Justin”) on the screen. The display apparatus 100 may display the UI 102 including the second message (“Hi Justin”) on the screen. The display apparatus 100 transmits the second message (“Hi Justin”) to the electronic device 200 to make the electronic device 200 transmit the second message (“Hi Justin”) to the external device that transmitted the first message (“Hi Michael”).

The user may utilize the message function associated with the electronic device 200 together with the electronic device 200, by using the display apparatus 100 and the control device 300.

The control device 300 may include a user input unit through which a text may be input, and may receive an input of a text corresponding to “Hi Justin” from the user. Alternatively, the microphone included in the control device 300 senses “Hi Justin” uttered by the user, and may obtain a voice signal corresponding to the utterance “Hi Justin”. The control device 300 may transmits a text message or a voice signal corresponding to “Hi Justin” to the display apparatus 100. The display apparatus 100 receiving the voice signal transforms the voice signal into a text message (“Hi Justin”), and displays the text message on the screen.

The user may use the messenger function via the display apparatus 100 and the control device 300, without approaching the display apparatus 100 and picking up the electronic device 200 in order to use the messenger function of the electronic device 200. Therefore, user's convenience may be greatly improved.

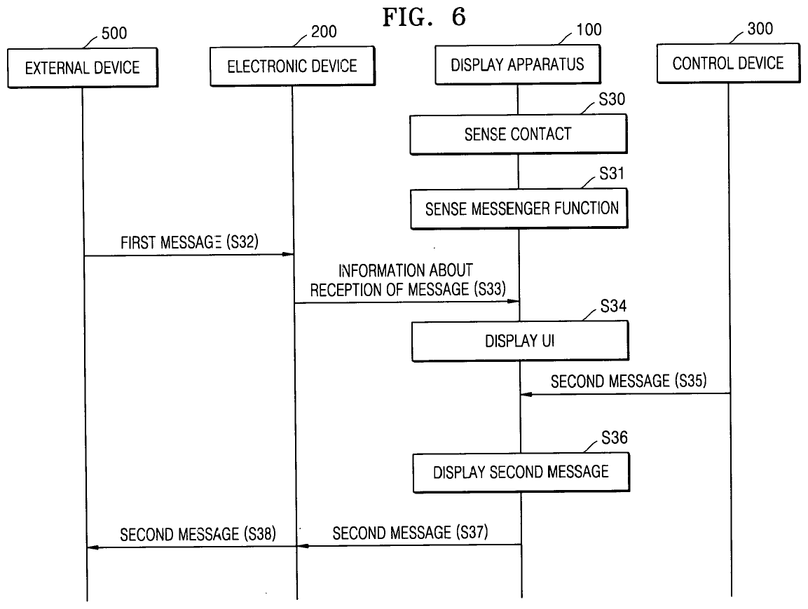

FIG. 6 is a flowchart illustrating a method of operating a display apparatus, an electronic device, and a control device performing a phone-call function, according to one or more embodiments.

Referring to FIG. 6, the display apparatus 100 may sense contact of the electronic device 200 (S30). The display apparatus 100 may sense a messenger function of the electronic device 200 (S31).

When receiving a first message from an external device (S32), the electronic device 200 may transmit information about reception of the message to the display apparatus 100 (S33). The information about the reception of the message may include information about the external device that transmitted the message, e.g., name of a user of the external device, phone number, etc. Also, the information about the reception of the message may further include the first message.

The display apparatus 100 may display a UI regarding the reception of the message (S34). The UI may allow the user to recognize the reception of the message or to manipulate the messenger function.

After S33, the display apparatus 100 may transmit to the control device 300 a control signal for performing the messenger function. The control device 300 receiving the control signal may perform operations related to the performance of messenger function. For example, when the control device 300 operates in one of a plurality of modes including a control mode for controlling the display apparatus 100 and a messenger function performing mode, the control device 300 receiving the control signal may operate in the messenger function performing mode. Alternatively, the control device 300 receiving the control signal may activate the microphone of the control device 300. Alternatively, the control device 300 may flicker a light-emitting diode (LED) module of the control device 300. The user may recognize that the control device 300 may perform the operations related to the performance of the messenger function, through the flickering of the LED module in the control device 300 and the UI output by the display apparatus 100.

The control device 300 may receive an input of a second message from the user, and may transmit the second message to the display apparatus 100 (S35). The display apparatus 100 may receive at least one of the second message and a voice signal corresponding to the second message from the control device 300. When the display apparatus 100 receives the voice signal, the display apparatus 100 may transform the voice signal into the second message.

The display apparatus 100 may display the second message on the screen (S36). The display apparatus 100 may display the UI 102 including the second message on the screen. The display apparatus 100 transmits the second message to the electronic device 200 (S37) to make the electronic device 200 transmit the second message to the external device 500 that transmitted the first message (S38).

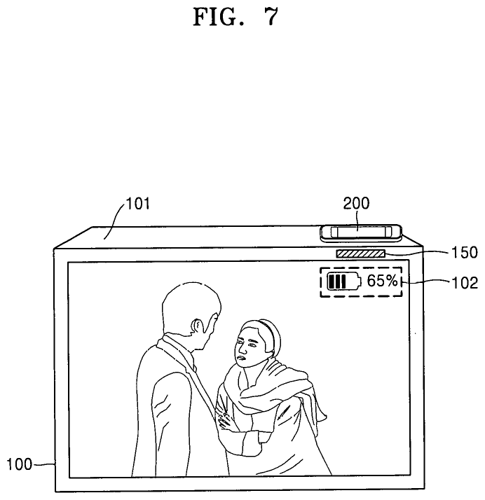

FIG. 7 shows an example in which a display apparatus according to one or more embodiments recognizes a wireless charging function of an electronic device.

Referring to FIG. 7, the display apparatus 100 may sense contact of the electronic device 200. The display apparatus 100 may sense a function associated with the electronic device 200, and the function may include a wireless charging function. The display apparatus 100 may wirelessly charge the electronic device 200.

The display apparatus 100 may include a wireless charger 150. The display apparatus 100 senses the contact of the electronic device 200, and when the display apparatus 100 senses the wireless charging function, the display apparatus 100 may turn on the wireless charger 150. The wireless charger 150 generates an electromagnetic field, and may supply electric power to the electronic device 200 that is electromagnetically coupled thereto.

The display apparatus 100 may activate function of the wireless charger 150 even in a turned-off state. For example, the screen of the display apparatus 100 is in a turn-off state, and when the display apparatus 100 senses the contact of the electronic device 200 and senses the wireless charging function, the display apparatus 100 may turn on the wireless charger 150.

The display apparatus 100 may display the UI 102 on the screen for manipulating the wireless charging function. The UI 102 may include information informing that the electronic device 200 is in the wireless charging state and information about a charged state of the electronic device 200. The UI 102 may include a UI that may turn on or turn off the wireless charging function.

The display apparatus 100 may output the UI 102 together with the A/V content that is currently being output. Therefore, the user may check the charged state of the electronic device 200 via the UI 102, while watching the A/V content that is being output on the display apparatus 100.

The display apparatus 100 may receive a user input for turning off the wireless charging function from the control device. The display apparatus 100 may turn off the wireless charger 150 to inactivate the wireless charging function.

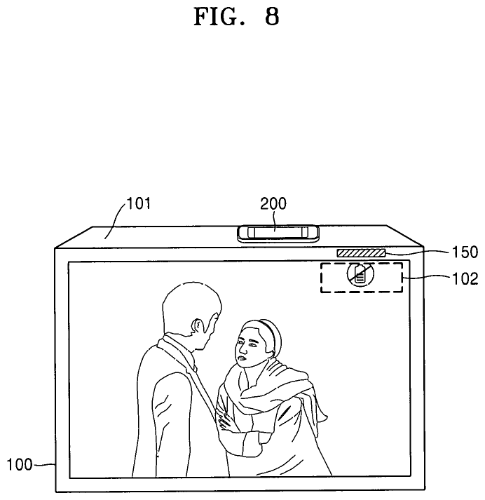

FIG. 8 shows another example in which a display apparatus according to one or more embodiments senses a wireless charging function of an electronic device.

Referring to FIG. 8, the display apparatus 100 senses the contact of the electronic device 200, and may sense the wireless charging function as a function associated with the electronic device 200.

When the electronic device 200 is not aligned with the wireless charger 150, the electronic device 200 may not be electromagnetically coupled to the wireless charger 150 and may not be charged.

The display apparatus 100 may sense that the electronic device 200 is out of a chargeable region. The display apparatus 100 may sense the location of the electronic device 200 or may sense that the electronic device 200 is not electromagnetically coupled to the wireless charger 150. The display apparatus 100 may display the UI 102 for notifying the user of that the electronic device 200 is not being charged. The display apparatus 100 may display the UI 102 on a location of the screen, which corresponds to the chargeable region. The user may move the electronic device 200 to a portion in the upper end portion 102, which corresponds to the point where the UI 102 is displayed, and then, the electronic device 200 may be wirelessly charged.

After moving the electronic device 200, when the display apparatus 100 senses that the electronic device 200 is on the chargeable region, the display apparatus 100 may not output the UI 102 shown in FIG. 8 any further, or may change the UI 102 of FIG. 8 into the UI 102 of FIG. 7 for representing the charged state of the electronic device 200.

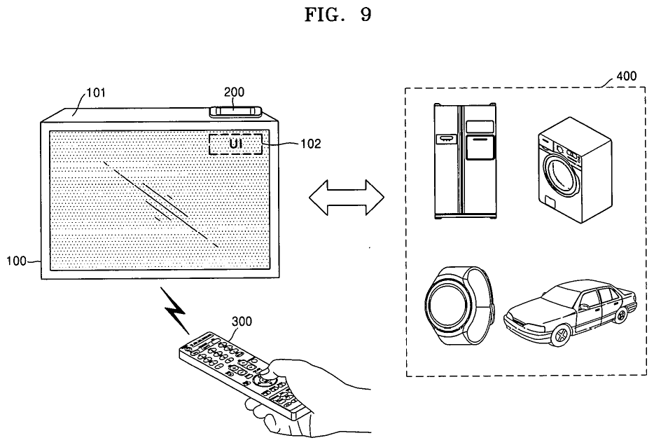

FIG. 9 shows an example in which a display apparatus according to one or more embodiments senses a remote control function of an electronic device.

Referring to FIG. 9, the display apparatus 100 senses the contact of the electronic device 200, and may sense a function associated with the electronic device 200. The sensed function may include a control function that the electronic device 200 may remotely control a controlled device 400.

The controlled device 400 may be a general device having a communication function thereon or an object. The controlled device 400 may be a general device or an object to which Internet of things (IoT) is applied. IoT denotes a technique of connecting various things, in which computer chips and a communication function are built, to Internet. For example, the controlled device 400 may include various electronic devices, e.g., a refrigerator, a washing machine, etc., various wearable devices, e.g., a smart watch, etc., an automobile, etc. Moreover, the controlled device 400 may include various sensors, e.g., a temperature sensor, a humidity sensor, an acoustic sensor, a motion sensor, a proximity sensor, a gas sensor, a heat sensor, lamps, a closed circuit television (CCTV), a fire alarm, household appliances, etc. The controlled device 400 may be any kind of device having a communication function thereon.

The display apparatus 100 may display the UI 102 on the screen for manipulating the remote control function. The display apparatus 100 may control the remote control function based on a user input transmitted from the control device 300. The display apparatus 100 may transmit a command for controlling the controlled device 400 based on the user input transmitted from the control device 300, to the electronic device 200. The electronic device 200 may transmit the command for controlling the controlled device 400 to the controlled device 400, and may control the controlled device 400.

For example, the UI 102 displayed by the display apparatus 100 may allow the user to recognize the remote control function or to manipulate the remote control function, in various ways. For example, the UI 102 may be represented in various ways, that is, providing the user with a list of the controlled devices 400 that may be remotely controlled by the electronic device 200, allowing the user to select the controlled device 400 to be remotely controlled, allowing the user to command the controlled device 400 to perform a desired operation, or allowing the user to certify authority of using the electronic device 200 or authority of controlling the controlled device 400. However, the UI 102 is not limited to the above-described example, and the display apparatus 100 may output the UI 102 in various ways, provided that interaction with the user may be performed.

For example, the display apparatus 100 may receive a user input for commanding to control a refrigerator from the control device 300. Examples of the user input may include a request for information about status of the refrigerator, e.g., a temperature of the refrigerator, and a command to control the refrigerator, e.g., opening/closing of a door of the refrigerator, adjusting of the temperature of the refrigerator, turning on/off the refrigerator, etc. The display apparatus 100 may transmit the user input for commanding to control the refrigerator to the electronic device 200, and thus, the electronic device 200 may control the refrigerator according to the user input. That is, the display apparatus 100 and the control device 300 may support interaction with the user with respect to the remote control function, and the electronic device 200 may actually communicate with the controlled device 400 and control the controlled device 400.

As another example, the display apparatus 100 may receive information, by which the controlled device 400 may be identified and communication with the controlled device 400 may be performed, from the electronic device 200. The information may include, for example, an Internet Protocol (IP) address of the controlled device 400. In addition, the display apparatus 100 may share the authority of controlling the controlled device 400 with the electronic device 200. In this case, the display apparatus 100 may directly control the controlled device 400 without using the electronic device 200.

The electronic device 200 may receive notification information from the controlled device 400. When the controlled device 400 is in a certain state set in advance, the controlled device 400 may transmit the notification information to the electronic device 200. For example, when the controlled device 400 is a refrigerator, the refrigerator may transmit notification information to the electronic device 200, wherein the notification information notifies the electronic device 200 of a state of open door, in a case where the door of the refrigerator is open for a predetermined time period or greater. When the controlled device 400 is a washing machine, the washing machine may transmit notification information for notifying finish of the washing operation to the electronic device 200. When the controlled device 400 is a wearable device, the wearable device may transmit notification information regularly to the electronic device 200, wherein the notification information includes body information of a user. However, the above notification information is an example, and the notification information is not limited thereto.

When the electronic device 200 receives the notification information from the controlled device 400, the electronic device 200 may notify the display apparatus 100 of reception of the notification information. The display apparatus 100 may display the UI 102 including the notification information on the screen. For example, the display apparatus 100 may display the UI 102 including the notification information on the screen as a pop-up.

The user may determine a control operation that is necessary for the controlled device 400 based on the notification information, and may input a user input corresponding to the control command of the controlled device 400 through the control device 300.

The display apparatus 100 may transmit a command for controlling the controlled device 400 based on the user input transmitted from the control device 300, to the electronic device 200. The electronic device 200 may transmit the command for controlling the controlled device 400 to the controlled device 400, and may control the controlled device 400. Alternatively, when the display apparatus 100 shares the authority of controlling the controlled device 400 with the electronic device 200, the display apparatus 100 may directly transmit the control command to the controlled device 400 without the electronic device 200.

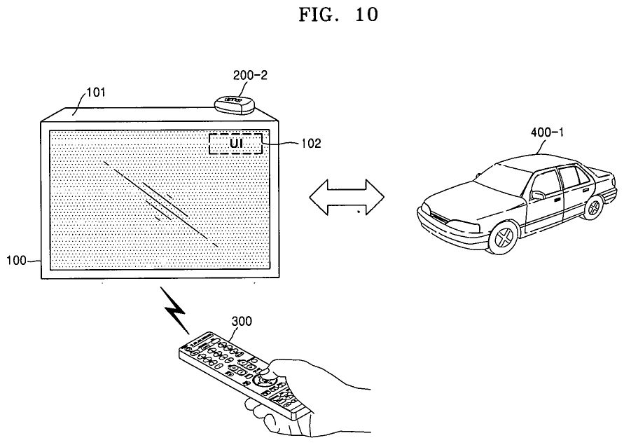

FIG. 10 is a diagram for describing a display apparatus and a smart key, according to one or more embodiments.

Referring to FIG. 10, a smart key 200-2 is placed on the upper end portion 101 of the display apparatus 100. The smart key 200-2 is a device capable of controlling a vehicle 400-1 without physically contacting or coupling to the vehicle 400-1. In a case of a general car key, a user may insert the car key into a key hole in the vehicle 400-1 to control the vehicle 400-1. The smart key 200-2 may control the vehicle via a wireless communication. For example, when the user gets on the vehicle 400-1 while carrying the smart key 200-2, the user may start or stop the vehicle 400-1 without inserting the smart key 200-2 into the key hole. When the user approaches the vehicle 400-1 while carrying the smart key 200-2, a door of the vehicle 400-1 may be unlocked.

Since the vehicle 400-1 has a communication function, the vehicle 400-1 may communicate with the smart key 200-2. Also, the vehicle 400-1 may be connected to Internet. The vehicle 400-1 may be an electric car or a smart car.

The display apparatus 100 may sense the contact of the smart key 200-2. The display apparatus 100 may sense that an electronic device contacting the display apparatus 100 is the smart key 200-2 that may control the vehicle 400-1. The display apparatus 100 may sense a remote control function of the vehicle 400-1, which is related to the smart key 200-2.

The display apparatus 100 may display the UI 102 about the remote control function of the vehicle 400-1 on the screen. The display apparatus 100 may receive a user input for controlling the vehicle 400-1 from the control device 300. Examples of the user input may include a command for controlling the vehicle 400-1, e.g., charging the vehicle 400-1, closing/opening doors of the vehicle 400-1, security monitoring of the vehicle 400-1, etc. The display apparatus 100 transmits the user input for commanding the control of the vehicle 400-1 to the smart key 200-2, and thus, the smart key 200-2 may control the vehicle 400-1 based on the user input. Alternatively, the display apparatus 100 may directly control the vehicle 400-1 without using the smart key 200-2.

The display apparatus 100 and the vehicle 400-1, or the smart key 200-2 and the vehicle 400-1 may communicate with each other via a server. The server may be configured to monitor a state of the vehicle 400-1, and to manage the vehicle 400-1.

The command to control the vehicle 400-1 may further include transmitting of information according to the user input to the vehicle 400-1. For example, a destination of the vehicle 400-1 may be transmitted to the vehicle 400-1 according to the user input. The vehicle 400-1 may transmit the destination to a navigation system included therein, and the navigation system may search for an optimal path. The optimal path found by the navigation system may be transmitted to the display apparatus 100. The UI 102 of the display apparatus 100 may output the optimal path found by the navigation system of the vehicle 400-1.

When the display apparatus 100 is outputting the A/V content, the display apparatus 100 may obtain location information related to the A/V content. For example, the A/V content may be a broadcast program introducing a good restaurant, and the display apparatus 100 may obtain location information of the good restaurant related to the A/V content from an A/V content provider. The display apparatus 100 may transmit the obtained location information to the vehicle 400-1 based on a user input. The vehicle 400-1 may transmit the location information to the navigation system included therein.

The UI 102 may include information about the vehicle 400-1. For example, the information about the vehicle 400-1 may include an identifier, the kind, model year, driving information, charging state, fuel state of the vehicle 400-1, replacement period of parts such as tires, air pressure of tires, state information of the vehicle 400-1, etc. The user may select desired information about the vehicle 400-1 through the UI 102 and the control device 300. That is, the display apparatus 100 may receive a user input for selecting information about the vehicle 400-1 from the control device 300 via the UI 102. The display apparatus 100 may output corresponding information about the vehicle 400-1 via the UI 102 based on the user input.

The information about the vehicle 400-1 may be stored in the smart key 200-2, in the vehicle 400-1, or on a server connected to the smart key 200-2 and the vehicle 400-1. The information about the vehicle 400-1 may be stored in a device included in the vehicle 400-1, e.g., a black box, a navigation system, etc. in the vehicle 400-1. For example, the information about the vehicle 400-1 may include images stored in the black box, paths stored in the navigation system, etc. The display apparatus 100 may request the smart key 200-2, the vehicle 400-1, the server, etc. for the information about the vehicle 400-1, based on the user input transmitted from the control device 300.

The smart key 200-2 may receive notification information from the vehicle 400-1. When the vehicle 400-1 is in a certain state set in advance, the vehicle 400-1 may transmit the notification information to the smart key 200-2. When the smart key 200-2 receives the notification information from the vehicle 400-1, the smart key 200-2 may notify the display apparatus 100 of the reception of the notification information. The display apparatus 100 may display the UI 102 including the notification information on the screen. As such, even when the smart key 200-2 is not adjacent to the user, the user may easily check the notification information through the display apparatus 100. In particular, when the notification information is important information regarding safety, utility of checking the notification information through the display apparatus 100 may be improved.

Although FIG. 10 illustrates the smart key 200-2, descriptions provided above with reference to FIG. 10 may be also applied to an electronic device capable of controlling the vehicle 400-1, in addition to the smart key 200-2.

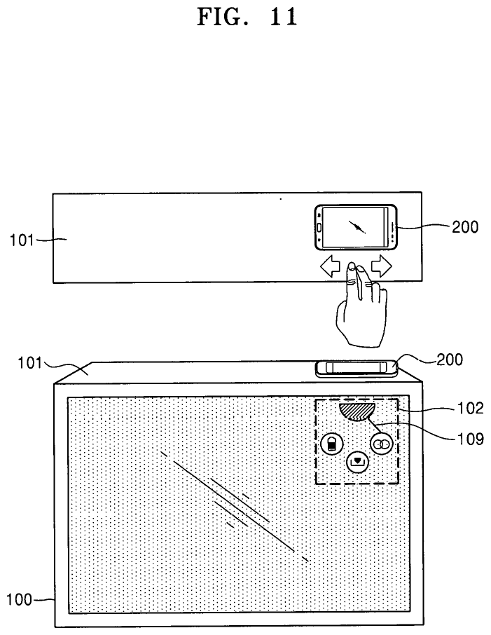

FIG. 11 shows an example in which a display apparatus according to one or more embodiments includes a touch pad.

Referring to FIG. 11, the display apparatus 100 senses the contact of the electronic device 200, and may sense a function associated with the electronic device 200. The display apparatus 100 may display the UI 102 on the screen for selecting the sensed function.

The UI 102 may include icons corresponding to the sensed functions, and may include an index line 109 representing an icon selected from among the icons. For example, it is assumed that three icons included in the UI 102 of FIG. 11 respectively correspond a wireless charging function, a data download function, and a phone-call or message link function sequentially from the left. In FIG. 11, the index line 109 is connected to the icon corresponding to the phone-call or message link function to represent that the phone-call or message link function is selected from among the functions associated with the electronic device 200.

The display apparatus 100 may include a touch pad for sensing a touch input of the user. The touch pad may be arranged on an upper end portion of the display apparatus 100. For example, the touch pad may be implemented as the upper end surface 101 or as a part of the upper end surface 101. When the user touches the upper end surface 101 of the display apparatus 100, the touch pad may sense a touch Input of the user.

The user may touch the upper end surface 101 by touching or dragging at a certain location in the upper end surface 101 of the display apparatus 100. The touch pad of the display apparatus 100 senses the touch input of the user and may exhibit a selected icon among a plurality of icons by adjusting a location of the index line 109 included in the UI 102 based on the touch input.

FIG. 11 shows an example of manipulating the UI 102 displayed on the screen of the display apparatus 100 by a touch input of the user. The UI 102 of the display apparatus 100 or the touch input type of the user are not limited to the example of FIG. 11.

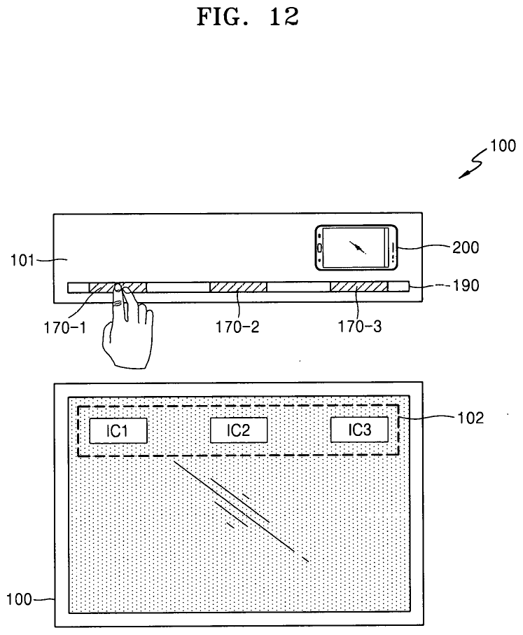

FIG. 12 shows an example in which a display apparatus according to one or more embodiments includes a touch pad and a light-emitting device.

Referring to FIG. 12, the display apparatus 100 may include a plurality of light-emitting devices 170. The light-emitting devices 170 may be arranged adjacent to the touch pad. For example, the plurality of light-emitting devices 170 may be arranged right under the touch pad implemented as the upper end surface 101 or a part of the upper end surface 101.

The UI 102 displayed on the display apparatus 100 may include a plurality of icons 101, IC2, and IC3 that the user may select. The display apparatus 100 may select light-emitting devices 170-1, 170-2, and 170-3 from among the plurality of light-emitting devices 170, wherein the light-emitting devices 170-1, 170-2, and 170-3 are at locations corresponding to the plurality of icons 101, IC2, and IC3. That is, locations of the plurality of icons 101, IC2, and IC3 on the screen may correspond to locations of the selected light-emitting devices 170-1, 170-2, and 170-3 at the upper end surface 101.

The display apparatus 100 makes the selected light-emitting devices 170-1, 170-2, and 170-3 emit light. The user may touch, among the light-emitting devices 170-1, 170-2, and 170-3, the light-emitting device at the location corresponding to the icon to be selected from among the plurality of icons 101, IC2, and IC3. For example, when the user wants to select the icon 101, the user may touch the light-emitting devices 170-1. When the touch pad senses a touch input of the user from the light-emitting devices 170-1, the display apparatus 100 selects the icon 101, and may perform an operation corresponding to the selected icon 101.

As shown in FIG. 12, the display apparatus 100 may selectively make the light-emitting devices 170 emit light, and thus, may guide the user about which part of the upper end surface 101 has to be touched.

On the screen of the display apparatus 100, the location of displaying the UI 102 may be related to orientation of the electronic device. The orientation of the electronic device 200 may denote at least one of a location, a direction, and a revolution of the electronic device 200.

The display apparatus 100 may obtain orientation information of the electronic device 200. The display apparatus 100 may determine the location to display the UI 102 on the screen thereof, based on the orientation information of the electronic device 200. The display apparatus 100 may include a sensor for obtaining the orientation information of the electronic device 200, e.g., a location sensor, a gyroscope sensor, etc. Alternatively, the display apparatus 100 may receive the orientation information of the display apparatus 100 from the electronic device 200. The electronic device 200 may obtain the orientation information thereof by using a sensor such as a location sensor, a gyroscope sensor, etc. included therein, and may transmit the orientation information to the display apparatus 100.

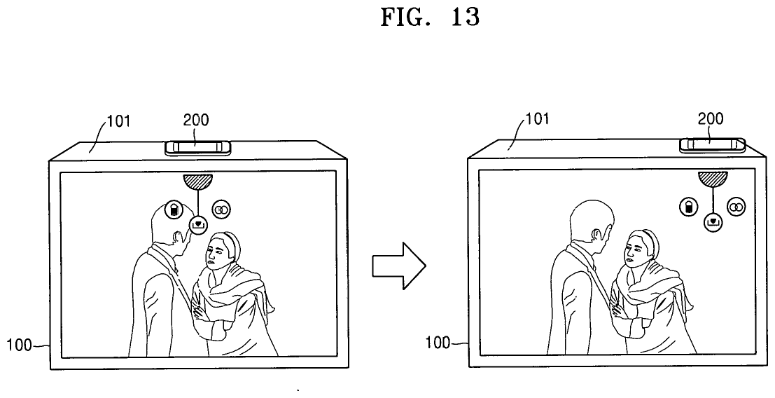

FIG. 13 illustrates a display apparatus according to one or more embodiments determining a location of displaying a UI on a screen according to a location of an electronic device.

Referring to FIG. 13, the display apparatus 100 may obtain the orientation information of the electronic device 200 and then may estimate that the electronic device 200 is located around a center of the upper end surface 101. The display apparatus 100 may output the UI 102 about the functions associated with the electronic device 200 around an upper center portion of the screen.

When the electronic device 200 is moved to a right side of the upper end surface 101, the display apparatus 100 may move the location of displaying the UI 102 to a right side from the upper center portion of the screen.

The display apparatus 100 may determine the location of displaying the UI 102 on the screen to be visually related to the location of the electronic device 200. As shown in FIG. 13, the UI 102 may be output on a portion of the screen, wherein the portion corresponds to a lower portion of the electronic device 200.

Alternatively, the functions associated with the electronic device 200 sensed by the display apparatus 100 may be related to the orientation of the electronic device 200.

The display apparatus 100 may obtain orientation information of the electronic device 200. The display apparatus 100 may select functions that are sensed to be related to the electronic device 200, based on the orientation information of the electronic device 200. When the display apparatus 100 senses a plurality of functions associated with the electronic device 200, the display apparatus 100 may select a function from among the plurality of functions, based on the orientation information of the electronic device 200.

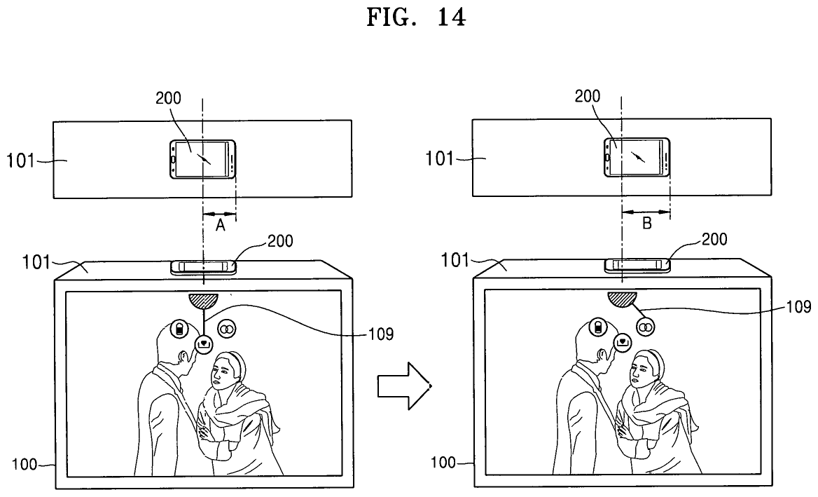

FIG. 14 illustrates a display apparatus according to one or more embodiments selecting one of functions associated with an electronic device according to an orientation of the electronic device.

Referring to FIG. 14, the display apparatus 100 may output the UI 102 regarding the sensed functions that are associated with the electronic device 200. The UI 102 may include icons corresponding to the sensed functions, and may include an index line 109 representing an icon selected from among the icons. For example, it is assumed that three icons included in the UI 102 of FIG. 14 respectively correspond a wireless charging function, a data download function, and a phone-call or message link function sequentially from the left.

The display apparatus 100 may estimate that the electronic device 200 is turned over based on the orientation information of the electronic device 200. That is, the display apparatus 100 may estimate that a screen of the electronic device 200 faces the upper end surface 101 of the display apparatus 100. The display apparatus 100 may select the data download function and Connect the index line 109 to the icon representing the data download function, and thus, it may be represented that the data download function is selected.

The display apparatus 100 may estimate that the screen of the electronic device 200 faces upward based on the orientation information of the electronic device 200. The display apparatus 100 may select the wireless charging function and connect the index line 109 to the icon representing the wireless charging function, and thus, it may be represented that the wireless charging function is selected.

However, FIG. 14 shows an example in which the display apparatus 100 selects one of the functions associated with the electronic device 200 according to the orientation information of the electronic device 200, and a relationship between the orientation information and the related functions selected according to the orientation information may be set in various ways.

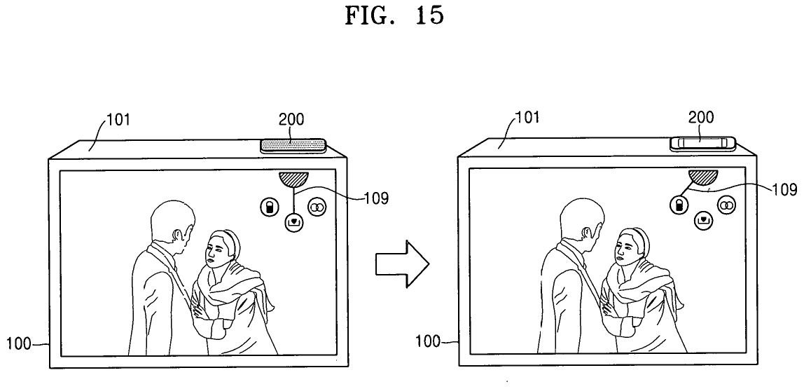

FIG. 15 illustrates a display apparatus according to one or more embodiments selecting an icon included in a UI, based on a degree of locational variation of an electronic device.

Referring to FIG. 15, the UI 102 displayed on the display apparatus 100 may include a plurality of icons and the index line 109 indicating a selected icon from among the plurality of icons. In a state where the index line 109 is connected to the icon representing the data download function, the display apparatus 100 may obtain a variation degree in the location of the electronic device 200, that is, as much as “B-A” to a right side. The display apparatus 100 may connect the index line 109 to an icon representing a link function, which is at a right side of the icon representing the data download function.

When the display apparatus 100 obtains the location variation degree of the electronic device 200, to be moved to a left side, not the right side, the display apparatus 100 may connect the index line 109 to an icon representing the wireless charging function, which is at a left side of the icon representing the data download function.

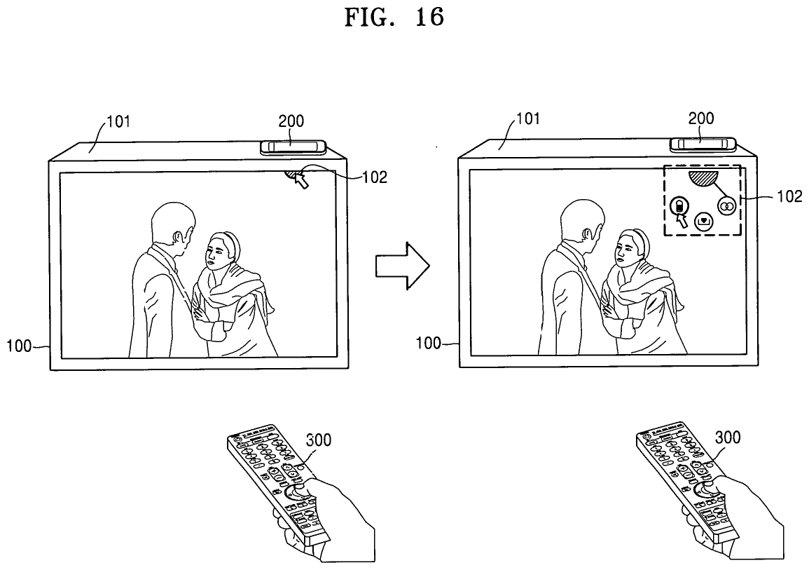

FIG. 16 shows an example in which a display apparatus according to one or more embodiments displays a UI on a screen.

Referring to FIG. 16, the display apparatus 100 may display the UI 102 about the electronic device 200 as an invisible type or a visible type on the screen. For example, the invisible type may be displayed on the screen as a dot or a button. The invisible type of the UI 102 may be displayed in a minimum size recognizable by the user. The display apparatus 100 may display the UI 102 as the invisible type, when a certain condition is satisfied, for example, there is no notification from the electronic device 200, there is no user input with respect to the UI 102 for a predetermined time period, etc. The display apparatus 100 may reduce an area blocked by the UI 102 in video content output on the display apparatus 100, by displaying the UI 102 in the invisible type. As such, the UI 102 may not interfere with the user watching the video content.

When the display apparatus 100 receives a user input for switching the UI 102 into the visible type, the display apparatus 100 may display the UI 102 in the visible type. For example, when the control device 300 moves and a pointer of the control device 300 points the UI 102 of the invisible type, the UI 102 of the invisible type may be switched into the visible type. When the UI 102 of the visible type includes a plurality of icons that may be selectable, the user may select a desired icon by adjusting the pointer of the control device 300.

FIG. 16 only shows an example in which the UI 102 is switched from the invisible type to the visible type, and the user input for switching the UI 102 into the visible type is not limited to the example. The user input for switching the UI 102 into the visible type may, include moving of the pointer via a direction key of the control device 300 or selection of a certain button in the control device 300.

Alternatively, when receiving a notification from the electronic device 200, the display apparatus 100 may switch the UI 102 from the invisible type to the visible type. For example, the notification from the electronic device 200 may include a notification of phone-call request, a notification of reception of a message, a notification about a controlled device of the electronic device 200, etc.

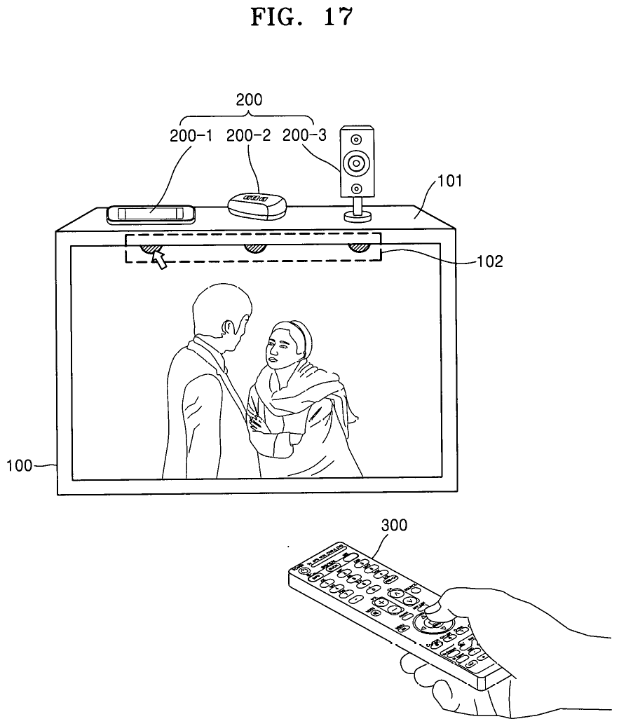

FIG. 17 shows an example in which a display apparatus according to one or more embodiments displays a UI on a screen.

Referring to FIG. 17, the display apparatus 100 may sense contacts of a plurality of electronic devices 200-1, 200-2, and 200-3. The display apparatus 100 may display the UIs 102 about functions associated with each of the plurality of electronic devices 200-1, 200-2, and 200-3. The display apparatus 100 displays the UIs 102 as invisible types, and from among the UIs 102, the UI having a user input for switching into the visible type may be switched the UI into the visible type. When the display apparatus 100 senses that the pointer points the UI of invisible type at a leftmost part of the UIs 102, the display apparatus 100 may switch the UI into the visible type.

The display apparatus 100 may determine a location of displaying each of the UIs 102 to be visually related to locations of the electronic devices 200-1, 200-2, and 200-3. For example, the UIs 102 of the electronic devices 200-1, 200-2, and 200-3 may be output to corresponding portions below the electronic devices 200 on the screen. When the user wants to switch the UI of the electronic device 200-1 into the visible type, the user may intuitively recognize that the UI under the electronic device 200-1 on the screen is the UI of the electronic device 200-1.

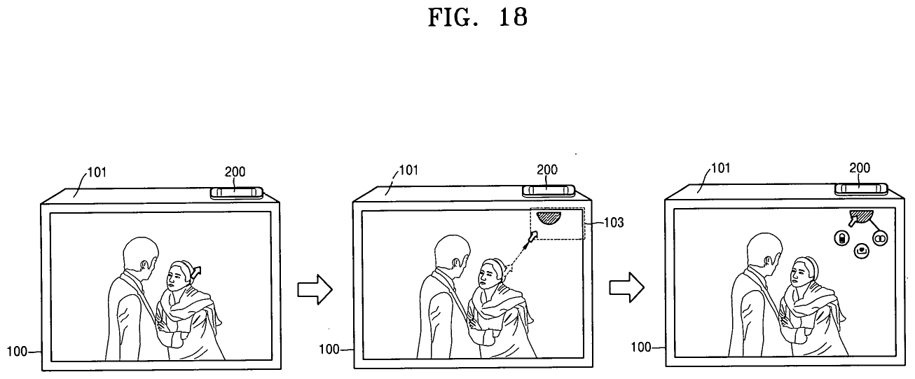

FIG. 18 shows an example in which a display apparatus according to one or more embodiments displays a UI on a screen.

Referring to FIG. 18, the display apparatus 100 may not display the UI 102 of about the electronic device 200, or may display the UI 102 about the electronic device 200 as an invisible type or a visible type.

The display apparatus 100 may set a display area 103 for the UI 102 on the screen. The display apparatus 100 does not display the UI 102 on the screen, and then, when sensing that the pointer of the control device 300 enters the display area 103, the display apparatus 100 may display the UI 102 as the invisible type.

When the pointer of the device 300 points the UI 102 in the invisible type, the display apparatus 100 may switch the UI 102 into the visible type.

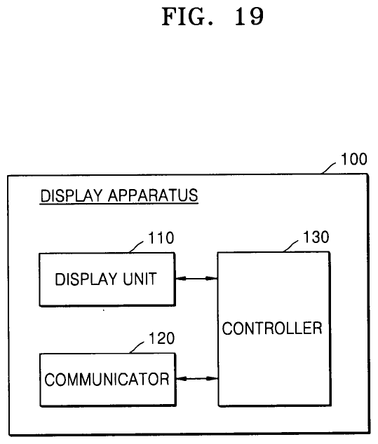

FIG. 19 is a block diagram of a display apparatus according to one or more embodiments.

Referring to FIG. 19, the display apparatus 100 may include a display unit 110, a communicator 120, and a controller 130.

The display unit 110 may output data processed by the display apparatus 100.

The communicator 120 is a unit allowing communication with various types of external devices according to various types of communication methods. The communicator 120 may include a communication module for performing communication in various types of communication methods. The communicator 120 may sense the contact of an electronic device, and may communicate with the electronic device.

The controller 130 controls overall operations of the display apparatus 100. In particular, the above-described operations of the display apparatus 100 may be performed by the controller 130. Although not described again, the above descriptions about the operations of the display apparatus 100 with reference to FIG. 19 may be performed by the display apparatus 100 of FIG. 19, in particular, by the controller 130. For example, the controller 130 may include a central processing unit (CPU), a micro-processor, a graphic processing unit (GPU), etc., but is not limited thereto.

The controller 130 may sense the contact to the display apparatus 100, and may sense functions associated with the electronic device that is communication. The controller 130 may display a UI for manipulating the sensed function on the display unit 110. The controller 130 may receive a user input for manipulating the functions via the UI from a control device.

The function sensed by the controller 130 may include a phone-call function of the electronic device. The controller 130 may output a first voice signal received from the electronic device to a sound output unit. The user input received by the controller 130 from the control device includes a second voice signal, and the controller 130 may transmit the second voice signal to the electronic device.

The function sensed by the controller 130 may include a messenger function of the electronic device. The UI displayed on the display unit 110 includes a first message transmitted from the electronic device, and the user input received by the controller 130 from the control device may include at least one of a second message and a voice signal corresponding to the second message. The controller 130 may display the second message on the display unit 110.

The function sensed by the controller 130 may include a remote control function allowing the electronic device to remotely control a controlled device. The controller 130 may transmit a command for controlling the controlled device to the electronic device, based on the user input transmitted from the control device.

The controller 130 may sense that the electronic device is a smart key that may control a vehicle, and the UI displayed on the display unit 110 may include information about the vehicle. The controller 130 may transmit a command to the vehicle, based on the user input transmitted from the control device.

When a security lock is set on the electronic device, the controller 130 may further display a UI for requesting for certification of authority of using the electronic device on the display unit 110.

Although not described again, the controller 130 may perform the operations performed by the display apparatus described above prior to FIG. 19.

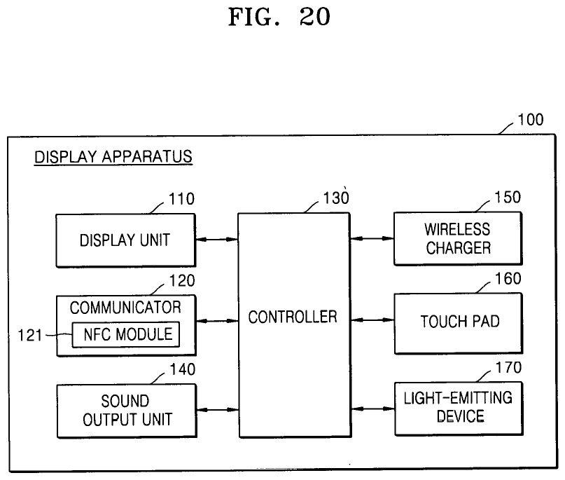

FIG. 20 is another block diagram of a display apparatus according to one or more embodiments. A display apparatus 100 of FIG. 20 may be another example of the display apparatus 100 of FIG. 19.

Referring to FIG. 20, the display apparatus 100 may include the display unit 110, the communicator 120, and the controller 130, and may further include a sound output unit 140, a wireless charger 150, and a touch pad 160.

The communicator 120 may include a near field communication (NFC) module 121. The NFC module 121 may sense contact of an electronic device. The NFC module 121 may be arranged on an upper end portion of the display apparatus 100.

The display apparatus 100 may provide the contacting electronic device with electric power via the wireless charger 150. The wireless charger 150 may be arranged adjacent to the NFC module 121. The wireless charger 150 and the NFC module 121 both may be arranged on the upper end portion of the display apparatus 100.

The touch pad 160 may be implemented together with the screen of the display apparatus 100, or may be arranged on the upper end portion of the display apparatus 100, not on the screen. The touch pad 160 may sense a touch input on a UI displayed on the display unit 110. The controller 130 may manipulate the function associated with the electronic device based on the user input transmitted from the control device and the touch input.

The display apparatus 100 may further include a plurality of light-emitting devices 170 that are arranged adjacent to the touch pad 160. When the UI displayed on the display unit 110 includes a plurality of icons that may be selected by the user, the controller 130 may select, from among the plurality of light-emitting devices 170, the light-emitting devices 170 at locations corresponding to locations of displaying the plurality of icons and may make the selected light-emitting devices 170 emit light.

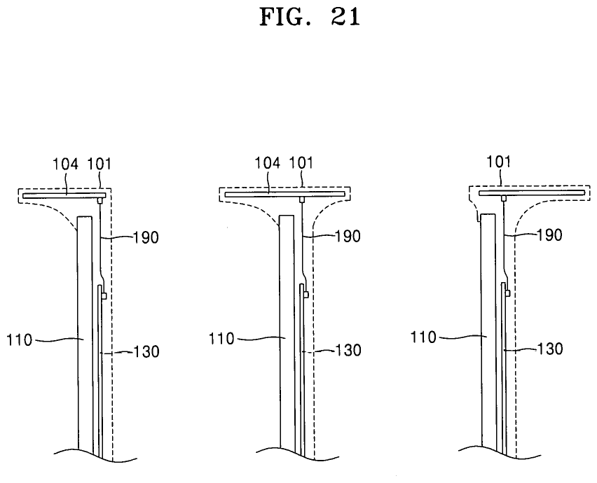

FIG. 21 is a side view of a display apparatus according to one or more embodiments.

Referring to FIG. 21, the display apparatus 100 may include the display unit 110, an upper end portion 104, and the controller 130. The display apparatus 100 may further include a cable 190 connecting the upper end portion 104 to the controller 130. The upper end portion 104 may include the NFC module 121, the wireless charger 150, the touch pad 160, and the light-emitting devices 170 described above with reference to FIG. 20.

The upper end portion 104 may be located under the upper end surface 101 of the display apparatus 100. The upper end portion 104 is perpendicular to the display unit 110. The upper end portion 104 may protrude from the display unit 110, and a protruding direction and a protruding degree of the upper end portion 104 may vary.

The controller 130 may be implemented on a board. Other elements of the display apparatus 100 may be implemented on the board. The communicator 120, except for the NFC module 121, may be implemented on the board.

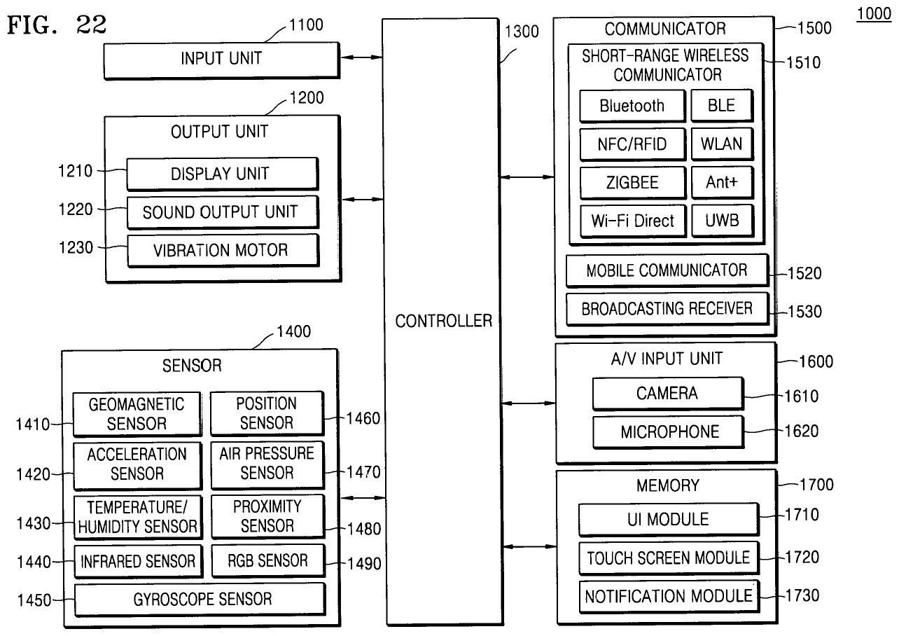

FIG. 22 is another block diagram of a display apparatus according to one or more embodiments. A display apparatus 1000 of FIG. 22 may be another example of the display apparatus 100 of FIG. 19 and FIG. 20. However, not all the elements shown in FIG. 22 are the essential elements of the display apparatus 1000. The display apparatus 1000 may include more or less elements than those shown in FIG. 22.

Referring to FIG. 22, the display apparatus 1000 may include a user input unit 1100, an output unit 1200, a controller 1300, a sensor 1400, a communicator 1500, an A/V input unit 1600, and a memory 1700.

The user input unit 1100 denotes a unit receiving data for controlling the display apparatus 1000. The user input unit 1100 may receive a user input for controlling the display apparatus 1000. For example, the user input unit 1100 may include, but is not limited to, a keypad, a dome switch, a touch pad (a capacitive overlay type, a resistive overlay type, an infrared beam type, a surface acoustic wave type, an integral strain gauge type, a piezoelectric type, etc.), a jog wheel, a jog switch, or the like. Also, for example, the user input unit 1100 may be an interface receiving a user input signal from an external input device (not shown).

The output unit 1200 may output an audio signal, a video signal, or a vibration signal, and may include a display unit 1210, a sound output unit 1220, and a vibration motor 1230.

The display unit 1210 may output data processed by the display apparatus 1000.

In addition, when the display unit 1210 and a touch pad are configured as a touch screen in a layered structure, the display unit 1210 may be used as an input device, in addition to as an output device. The display unit 1210 may include at least one of a liquid crystal display, a thin film transistor-liquid crystal display, an organic light-emitting diode, a flexible display, a three-dimensional (3D) display, and an electrophoretic display. In addition, the display apparatus 1000 may include two or more display units 1210 according to an implementation thereof. Here, the two or more display units 1210 may be arranged facing each other by using a hinge.

The sound output unit 1220 outputs audio content transmitted from the communicator 1500 or stored in the memory 1700. Also, the sound output unit 1220 outputs a sound signal related to the functions performed in the display apparatus 1000 (e.g., call signal reception sound, message reception sound, and notification sound). The sound output unit 1220 may include a speaker, a buzzer, etc.

The vibration motor 1230 may output a vibration signal. For example, the vibration motor 1230 may output a vibration signal corresponding to an output of audio content or video content (e.g., call signal reception sound, message reception sound, etc.) Also, the vibration motor 1230 may output a vibration signal when a touch input is received by the touch screen.

The controller 1300 generally controls overall operations of the display apparatus 1000. The controller 1300 may control other elements in the display apparatus 1000 for performing the above-described operations of the display apparatus 1000. For example, the controller 1300 may execute programs stored on the memory 1700 to control the user input unit 1100, the output unit 1200, the sensor 1400, the communicator 1500, the A/V input unit 1600, etc.

In detail, the controller 1300 senses the contact to the display apparatus 1000, and functions associated with an electronic device. The controller 130 may display a UI for manipulating the sensed function on the output unit 1200. The controller 1300 may receive a user input for manipulating the functions via the UI from a control device.

The function sensed by the controller 1300 may include a phone-call function of the electronic device. The controller 130 may output a first voice signal received from the electronic device to the sound output unit 1220. The user input received by the controller 1300 from the control device includes a second voice signal, and the controller 1300 may transmit the second voice signal to the electronic device.

The function sensed by the controller 1300 may include a messenger function of the electronic device. The UI displayed on the display unit 1210 includes a first message transmitted from the electronic device, and the user input received by the controller 1300 from the control device may include at least one of a second message and a voice signal corresponding to the second message. The controller 1300 may display the second message on the display unit 1210.

The function sensed by the controller 1300 may include a remote control function allowing the electronic device to remotely control a controlled device. The controller 1300 may transmit a command for controlling the controlled device to the electronic device, based on the user input transmitted from the control device.

The controller 1300 may sense that the electronic device is a smart key that may control a vehicle, and the UI displayed on the display unit 1210 may include information about the vehicle. The controller 1300 may transmit a command to the vehicle, based on the user input transmitted from the control device.

When a security lock is set on the electronic device, the controller 1300 may further display a UI for requesting for certification of authority of using the electronic device on the display unit 1210.

Although not described again, the controller 1300 may perform the operations performed by the display apparatus described above prior to FIG. 22.

The sensor 1400 senses a status of the display apparatus 1000 or a peripheral status of the display apparatus 1000, and may transmit sensed information to the controller 1300.

The sensor 1400 may include, but is not limited to, at least one of a magnetic sensor 1410, an acceleration sensor 1420, a temperature/humidity sensor 1430, an infrared ray sensor 1440, a gyroscope sensor 1450, a location sensor (e.g., a global positioning system (GPS)) 1460, an atmospheric pressure sensor 1470, a proximity sensor 1480, and an RGB sensor (illuminance sensor) 1490. Since one or ordinary skill in the art may intuitively infer functions of the sensors from the sensors' names, detailed descriptions thereof are omitted.

The controller 1300 may obtain orientation information of the electronic device, and may determine a location of displaying the UI on the display unit 1210 or may select the sensed function based on the orientation information. The orientation information of the electronic device may be obtained by the sensor 1400.

The communicator 1500 may include a short-range wireless communicator 1510, a mobile communicator 1520, and a broadcast receiver 1530.

The short-range wireless communicator 1510 may include, but is not limited to, a Bluetooth communicator, a Bluetooth low energy (BLE) communicator, an NFC module, a radio frequency identification (RFID) module, a wireless local area network (WLAN) communicator, a ZigBee communicator, an infrared data association (IrDA) communicator, a Wi-Fi direct (WFD) communicator, an ultra wideband (UWB) communicator, an Ant+ communicator, etc.

The NFC module may sense contact of an electronic device. The NFC module may be arranged on an upper end portion of the display apparatus 1000.

The mobile communicator 1520 may transmit/receive a wireless signal to/from at least one of a base station, an external terminal, and a server on a mobile communication network. Here, the wireless signal may include a voice call signal, a video call signal, or various types of data according to transmission/reception of texts/multimedia messages.

The broadcast receiver 1530 receives a broadcast signal and/or broadcast-related information from outside via a broadcast channel. The broadcast channel may include satellite channels and terrestrial channels.

The A/V input unit 1600 is for inputting an audio signal or a video signal, and may include a camera 1610, a microphone 1620, etc. The camera 1610 may obtain a still image, a video, etc. by using an image sensor in a video call mode or a photographing mode. An image captured by the image sensor may be processed by the controller 1300 or an additional image processor (not shown).

The still image or the video processed by the camera 1610 may be stored in the memory 1700 or may be transmitted to outside via the communicator 1500. The camera 1610 may obtain image data such as a still image or a video of the user. The controller 1300 may sense a motion gesture by analyzing the image data obtained by the camera 1610.

The microphone 1620 receives a sound signal from outside and processes the sound signal as electrical voice data. For example, the microphone 1620 may receive a sound signal from an external device or a narrator. The microphone 1620 may use various noise cancelling algorithms for cancelling noise generated when receiving the sound signal from the outside.

The memory 1700 may store programs for processing and controlling the controller 1300, and may store data input to or output from the display apparatus 1000.

The memory 1700 may include a storage medium of at least one type of a flash memory type, a hard disk type, a multimedia card micro type, a card type memory (e.g., an SD or XD memory, etc.), random access memory (RAM), a static RAM (SRAM), a read-only memory (ROM), an electrically erasable programmable ROM (EEPROM), a programmable (PROM), a magnetic memory, a magnetic disk, and an optical disk.

The programs stored in the memory 1700 may be classified as a plurality of modules according to functions thereof, for example, a UI module 1710, a touch screen module 1720, a notification module 1730, etc.

The UI module 1710 may provide specified UI, GUI, etc. connected to the display apparatus 1000 for each application. The touch screen module 1720 senses a touch gesture of the user on the touch screen, and may transmit information about the touch gesture to the controller 1300. The touch screen module 1720 according to some embodiments may sense and analyze a touch code. The touch screen module 1720 may be configured as additional hardware including a controller.

In order to sense a touch or a proximity touch on the touch screen, various sensors may be provided in or around the touch screen. An example of the sensor for sensing the touch on the touch screen may include a tactile sensor. A tactile sensor is a sensor for sensing contact of a certain object at a human sense level or higher. The tactile sensor may sense various information such as roughness of a contact surface, hardness of a contact material, a temperature at a contact point, etc.

Also, an example of the sensor for sensing the touch on the touch screen may include a proximity sensor.

The proximity sensor denotes a sensor for sensing an existence of an object approaching a predetermined detect surface or an object around the detect surface by using an electromagnetic field or an infrared ray, without a physical contact. Examples of the proximity sensor may include a transmission type photoelectric sensor, a direct reflective photoelectric sensor, a mirror reflective photoelectric sensor, a radio frequency oscillation type proximity sensor, a capacitive type proximity sensor, a magnetic type proximity sensor, an infrared ray proximity sensor, etc. The touch gesture of the user may include a tap gesture, a touch & hold gesture, a double tap gesture, a drag gesture, a panning gesture, a flick gesture, a drag & drop gesture, a swipe gesture, or the like.

The notification module 1730 may generate a signal for notifying occurrence of an event in the display apparatus 1000. Examples of the event occurring in the display apparatus 1000 may include a call signal reception, a message reception, a key signal reception, a schedule notification, etc. The notification module 1730 may output a notification signal as video content through the display unit 1210, may output a notification signal as an audio signal through the sound output unit 1220, or may output the notification as a vibration signal through the vibration motor 1230.

The display apparatus 1000 may further include a wireless charger. The display apparatus 1000 may provide the contacting electronic device with electric power via the wireless charger. The wireless charger may be arranged adjacent to the NFC module of the short-range wireless communicator 1510. The wireless charger and the NFC module may be both arranged on the upper end portion of the display apparatus 1000.

The display apparatus 1000 may further include a touch pad. The touch pad may be arranged on an upper end portion of the display apparatus 1000. The touch pad may sense a touch input on a UI displayed on the display unit 1210. The controller 1300 may manipulate the function associated with the electronic device based on the user input transmitted from the control device and the touch input.

The display apparatus 1000 may further include a plurality of light-emitting devices arranged adjacent to the touch pad. When the UI displayed on the display unit 1210 includes a plurality of icons that may be selected by the user, the controller 1300 may select, from among the plurality of light-emitting devices, the light-emitting devices at locations corresponding to locations of displaying the plurality of icons and may make the selected light-emitting devices emit light.

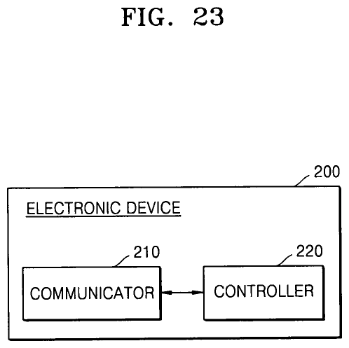

FIG. 23 is a block diagram of an electronic device according to one or more embodiments.

Referring to FIG. 23, the electronic device 200 may include a communicator 210 and a controller 220.

The communicator 210 is a unit allowing communication with various types of external devices according to various types of communication methods. The communicator 210 may include a communication module for performing communication in various types of communication methods. The communicator 210 may communicate with the display apparatus in contact with the electronic device 200.

The controller 220 may control overall operations of the electronic device 200. In particular, the above-described operations of the controller 220 may be performed by the controller 220. The controller 220 may control the operations of the electronic device 200, and thus, the functions of the electronic device 200 may be linked with the display apparatus.

For example, the controller 220 may include a central processing unit (CPU), a micro-processor, a graphic processing unit (GPU), etc., but is not limited thereto.

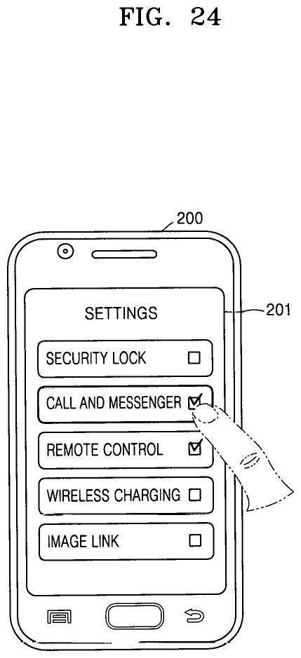

FIG. 24 shows an example of a screen of an electronic device according to one or more embodiments.

Referring to FIG. 24, the electronic device 200 may display a UI 201 that may be set with respect to linking with the display apparatus. The UI 201 may include a list of the functions that may be linked with the display apparatus. Also, the UI 201 may be implemented to select a function to be linked with the display apparatus, from among the functions that may be linked in the list, according to a user input.

The UI 201 may include a phone-call and messenger function, a remote control function on a controlled device, a wireless charging function, and a video link function, as the functions that may be linked with the display apparatus. Since the phone-call and messenger function, the remote control function on the controlled device, and the wireless charging function are described above with reference to previous embodiments, detailed descriptions thereof are omitted. The video link function may be a function for outputting a video, an image, etc. stored in the electronic device 200 from the display apparatus, and controlling the video, the image, etc. via the display apparatus. FIG. 24 shows that the phone-call and messenger function and the remote control function are selected. However, the UI 201 shown in FIG. 24 is an example, and the electronic device 200 may variously provide the UI 201 that may be set with respect to the link with the display apparatus, and the list of the functions that may be linked with the display apparatus in the UI 201 is not limited to the above example.

The electronic device 200 may set security lock setting with respect to the linkage between the electronic device 200 and the display apparatus by using the UI 201. When the electronic device 200 set security with respect to the linkage, the display apparatus.

As shown in FIG. 24, when the electronic device 200 selects the phone-call and messenger function and the remote control function without setting the security lock via the UI 201, the electronic device 200 may directly link the phone-call and messenger function and the remote control function with the display apparatus without requesting the display apparatus for certification when contacting the display apparatus.

That is, when the display apparatus senses the contact of the electronic device 200, the display apparatus may sense the phone-call and messenger function and the remote control function. The display apparatus may perform the phone-call and messenger function and the remote control function, and may display a UI for manipulating the functions on the screen thereof. Alternatively, the display apparatus may sense all the functions of the electronic device 200, which may be linked with the display apparatus (e.g., the phone-call and messenger function, the remote control function on the controlled device, the wireless charging function, the image link function). The display apparatus may only perform allowed functions (the phone-call and messenger function and the remote control function), among the sensed functions. When the display apparatus receives a user input for selecting non-allowed functions (the wireless charging function and the image link function) through the control device (300 of FIG. 1) or the touch pad of the display apparatus, the display apparatus may display a UI c

When the electronic device 200 sets the security lock via the UI 201, the electronic device 200 may only link with the display apparatus that is certified about the authority of using the electronic device 200 or the authority of controlling the functions associated with the electronic device 200. For example, the display apparatus sensing the contact of the electronic device 200 may output a UI for certifying the authority of using the electronic device 200 or the authority of controlling the functions associated with the electronic device 200. After the certification, the electronic device 200 may link with the display apparatus.

As described above, the electronic device 200 may perform settings with respect to the linkage with the display apparatus in advance, and thus, issues such as personal information leakage, invasion of privacy, etc. occurring when the display apparatus operates being linked with the electronic device 200 may be prevented.

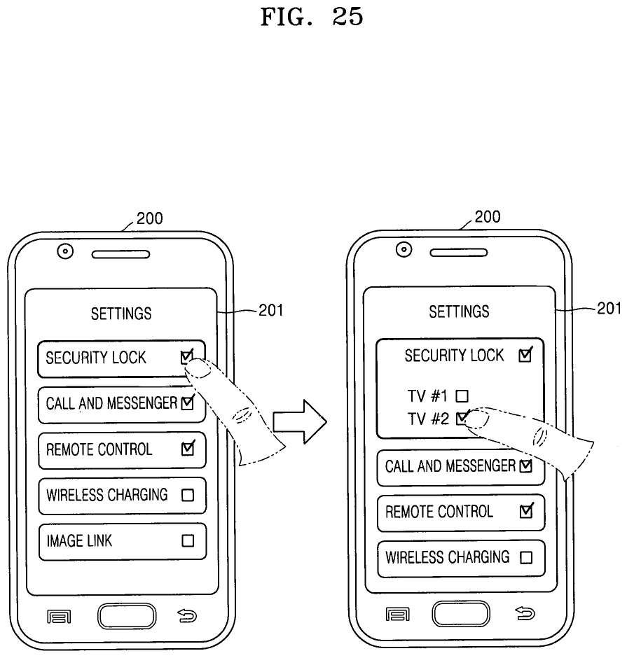

FIG. 25 shows an example of a screen of an electronic device in a case where a security lock is set on an electronic device, according to one or more embodiments.

Referring to FIG. 25, the security lock of the electronic device 200 may be set by a user input through the UI 201. When the security lock is set, the electronic device 200 may search for an adjacent display apparatus. For example, the electronic device 200 may search for a display apparatus connected via a near field network, or search for a display apparatus through a discovery process.

The electronic device 200 may output a list of one or more display apparatuses TV #1 and TV #2 that are found in the UI 201. Also, the UI 201 may be configured to select a display apparatus, security lock of which may not be set, between the one or more display apparatuses TV #1 and TV #2 in the list, according to the user input. That is, the electronic device 200 may selectively set the security lock of the one or more display apparatuses TV #1 and TV #2 that are found.

As shown in FIG. 25, it is assumed that the security lock is set for the first display apparatus TV #1 and the security lock is not set for the second display apparatus TV #2. The first display apparatus TV #1 sensing the contact of the electronic device 200 may output a UI for certifying the authority of using the electronic device 200 or the authority of controlling the functions associated with the electronic device 200. After the certification, the electronic device 200 may link with the first display apparatus TV #1. Since the second display apparatus TV #2 sensing the contact of the electronic device 200 is not set for the security lock, the second display apparatus TV #2 may be directly linked with the electronic device 200.

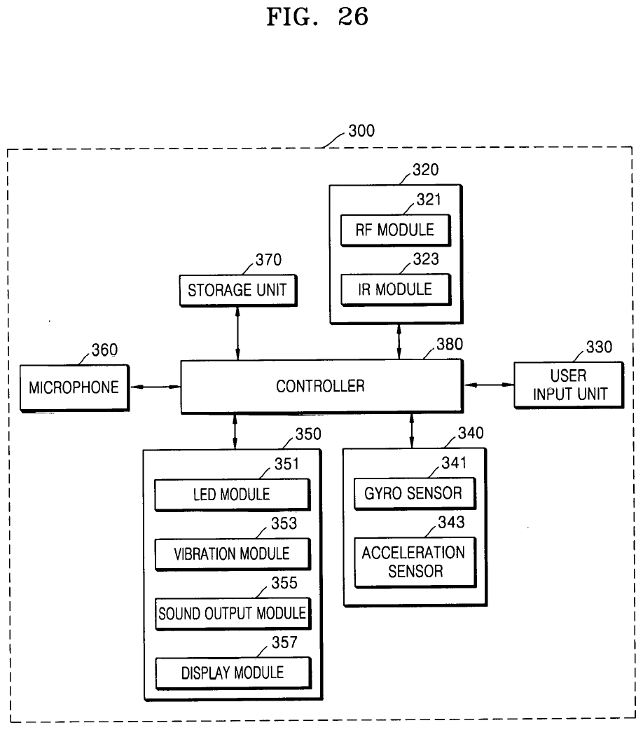

FIG. 26 is a block diagram of a control device according to one or more embodiments.

Referring to FIG. 26, the control device 300 may include a communicator 320, a user input unit 330, a sensor 340, an output unit 350, a microphone 360, a storage unit 370, and a controller 380.

The communicator 320 may transmit/receive signals to/from the display apparatus 100 according to the above-described embodiments. The communicator 320 may include a radio frequency (RF) module 321 that may transmit/receive signals to/from the display apparatus 100 according to an RF communication standard. Also, the control device 300 may include an infrared ray (IR) module that may transmit/receive signals to/from the display apparatus 100 according to an IR communication standard.

The user input unit 330 may include a keypad, a button, a touch pad, a touch screen, etc. A user may input a command related to the display apparatus 100 to the control device 300 by manipulating the user input unit 330. When the user input unit 330 includes a hard key button, the user may input the command related to the display apparatus 100 to the control device 300 by pushing the hard key button. When the user input unit 330 includes a touch screen, the user may input the command related to the display apparatus to the control device 300 by touching a soft key in the touch screen.

Also, the user input unit 330 may include various kinds of input units that may be manipulated by the user, e.g., a scroll key, a jog key, etc.

Also, the user input unit 330 may include a touch pad. The user input unit 330 according to the embodiment may receive a user input through dragging, touching, or flipping on the touch pad of the control device 300. Also, the display apparatus may be controlled according to a kind of the received user input (for example, a direction of receiving the drag command or a time of receiving the touch command).

The user may input the user input for manipulating the functions associated with the electronic device to the control device 300, after checking the UI for manipulating the functions associated with the electronic device displayed on the display apparatus.

The sensor 340 may include a gyro sensor 341 or an acceleration sensor 343. The gyro sensor 341 may sense motion information of the control device 300. As an example, the gyro sensor 341 may sense information about the operation of the control device 300 based on x, y, and z axes. The acceleration sensor 343 may sense information about velocity of the control device 300, etc. In addition, a distance measuring sensor may be further provided, and as such, a distance to the display apparatus may be sensed.

The output unit 350 may output an image or voice signal corresponding to the manipulation of the user input unit 330 or corresponding to a signal transmitted from the display apparatus. Through the output unit 350, the user may recognize whether the user input unit 330 is manipulated or the display apparatus 100 is controlled.

As an example, the output unit 350 may include a light-emitting diode (LED) module 351 that is lighted, a vibration module 353 that generates vibration, an acoustic output module 355 that outputs sound, or a display module 357 that outputs an image, when the user input unit 330 is manipulated or the signal is exchanged with the display apparatus 100 via the communicator 320.

The microphone 360 receives a sound signal from outside and processes the sound signal as electrical voice data. The microphone 360 may sense voice of the user, and obtain a voice signal. The controller 380 may obtain the voice signal as the user input. The controller 380 may control operations of the control device 300 based on the voice signal or transmit the voice signal to the display apparatus.

The controller 380 may activate the microphone 360 based on a control signal transmitted from the display apparatus via the communicator 320.

The storage unit 370 may store various kinds of programs, application data, etc. necessary for controlling or operating the control device 300.

The controller 380 controls all matters regarding the control of the control device 300. The controller 380 may transmit a signal corresponding to the manipulation of a predetermined key in the user input unit 330 or motion information of the control device 300 sensed by the sensor 340, to the display apparatus 100 via the communicator 320.

The controller 380 controls the gyro sensor 341 and the RF module 321 to make the RF module 321 transmit the motion information of the control device 300 sensed by the gyro sensor 341 to the display apparatus.

When a command related to the display apparatus 100 is input through the user input unit 330, the controller 380 controls the communicator 320 to make the communicator 320 transmit the command to the display apparatus.

The control device 300 may further include a power supplier. The power supplier supplies electric power to the control device 300. The power supplier may reduce power consumption by stopping the power supply in a case where the control device 300 does not move for a predetermined time period. The power supplier may restart the power supply when a predetermined key included in the control device 300 is manipulated.

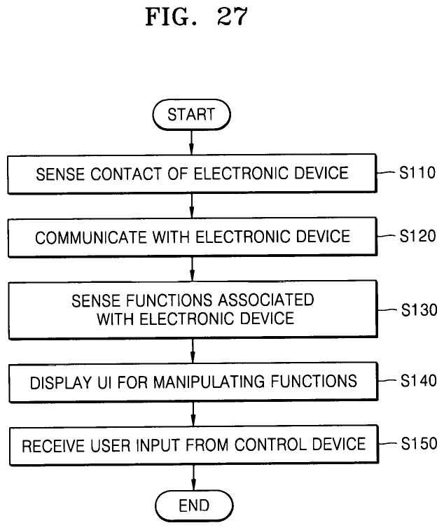

FIG. 27 is a flowchart illustrating a method of operating a display apparatus according to one or more embodiments.

Referring to FIG. 27, a display apparatus may sense contact of an electronic device (S110). The display apparatus may communicate with the electronic device, the contact of which is sensed (S120). The display apparatus may sense functions associated with the electronic device (S130). The display apparatus may display a UI on a screen thereof for manipulating the sensed function (S140). The display apparatus may receive, from a control device, a user input for manipulating the function associated with the electronic device with respect to the displayed UI (S150).

The function associated with the electronic device sensed by the display apparatus may include a phone-call function of the electronic device. The display apparatus may output a first voice signal transmitted from the electronic device. The user input received by the display apparatus from the control device may include a second voice signal. The display apparatus may transmit the second voice signal to the electronic device.

The function associated with the electronic device sensed by the display apparatus may include a messenger function of the electronic device. The UI displayed on the screen of the display apparatus may include a first message transmitted from the electronic device. The user input received by the display apparatus from the control device may include at least one of the second message and a voice signal corresponding to the second message. The display apparatus may display the second message on the screen thereof.

The function associated with the electronic device sensed by the display apparatus may include a remote control function allowing the electronic device to remotely control a controlled device. The display apparatus may transmit a command for controlling the controlled device to the electronic device, based on the user input transmitted from the control device.

The display apparatus may sense that the electronic device is a smart key that may control a vehicle. The UI displayed on the screen of the display apparatus may include information about the vehicle. The display apparatus may transmit a command to the vehicle, based on the user input transmitted from the control device.

The display apparatus may sense a touch input with respect to the UI displayed on the screen, via a touch pad arranged on an upper end portion of the display apparatus. The display apparatus may manipulate the function associated with the electronic device based on the user input transmitted from the control device and the touch input.

When the UI displayed on the display apparatus includes a plurality of icons that may be selected by the user, the display apparatus may select, from among the plurality of light-emitting devices arranged adjacent to the touch pad, the light-emitting devices at locations corresponding to locations of displaying the plurality of icons and may make the selected light-emitting devices emit light.

The display apparatus may obtain orientation information of the electronic device. The display apparatus may determine a location of displaying the UI on the screen thereof or may select the function associated with the electronic device, based on the orientation information.

When a security lock is set on the electronic device, the display apparatus may further display a UI for requesting for certification of authority of using the electronic device on the screen of the display apparatus.

The operation method of the display apparatus illustrated in FIG. 27 may be executed by the display apparatus 100 or 1000 shown in the previous drawings. Although not described again, the display apparatus may further perform the operations performed by the display apparatus described above prior to FIG. 27.

On the other hand, embodiments of the present disclosure described above may be implemented in a general purpose digital computer to be written as a program that may be executed on a computer, and operate the programs using a computer readable recording medium.

The computer readable recording medium include magnetic storage media (e.g., ROM, floppy disks, hard disks, etc.), and optical recording media (e.g., CD-ROMs, DVDs, etc.).

While the present disclosure has been particularly illustrated and described with reference to exemplary embodiments thereof, it will be understood by those of ordinary skill in the art that various changes in form and details may be made therein without departing from the spirit and scope of the present disclosure. Thus, the embodiments set forth herein or shown above are to be interpreted in an illustrative and non-limiting sense.

1. A display apparatus comprising:
a display unit;
a communicator configured to sense contact of an electronic device and to communicate with the electronic device; and
a controller configured to sense a function associated with the electronic device, to display a user interface (UI) on the display unit for manipulating the sensed function, and to receive, from the control device, a user input for manipulating the function with respect to the UI.

2. The display apparatus of claim 1, further comprising a sound output unit,
wherein the function sensed by the controller comprises a phone-call function of the electronic device,
the controller is further configured to output a first voice signal received from the electronic device to the sound output unit, and
the user input received by the controller from the control device comprises a second voice signal and the controller is further configured to transmit the second voice signal to the electronic device.

3. The display apparatus of claim 1, wherein the function sensed by the controller comprises a messenger function of the electronic device,
the UI displayed on the display unit comprises a first message transmitted from the electronic device, and
the user input received by the controller from the control device comprises at least one of a second message and a voice signal corresponding to the second message, and the controller is further configured to display the second message on the display unit.

4. The display apparatus of claim 1, wherein the function sensed by the controller comprises a remote control function allowing the electronic device to remotely control a controlled device, and the controller is further configured to transmit a command for controlling the controlled device to the electronic device, based on the user input received from the control device.

5. The display apparatus of claim 1, wherein the controller senses that the electronic device is a smart key capable of controlling a vehicle, the UI displayed on the display unit comprises information about the vehicle, and the controller is further configured to transmit a control command based on the user input received from the control device to the vehicle.

6. The display apparatus of claim 1, further comprising a wireless charger configured to provide the electronic device with electric power, wherein the communicator comprises a near field communication (NFC) module configured to sense the contact of the electronic device, the NFC module is arranged on an upper end portion of the display apparatus, and the wireless charger is arranged on the upper end portion to be adjacent to the NFC module.

7. The display apparatus of claim 1, wherein the controller is further configured to obtain orientation information of the electronic device, and to determine a location of displaying the UI on the display unit or to select the sensed function, based on the orientation information.

8. An operation method of a display apparatus, the operation method comprising:
sensing contact of an electronic device and communicating with the electronic device;
sensing a function associated with the electronic device and displaying a user interface (UI) for manipulating the sensed function on a screen of the display apparatus; and
receiving, from a control device, a user input for manipulating the function with respect to the UI.

9. The operation method of claim 8, further comprising:
when the sensed function comprises a phone-call function of the electronic device, outputting a first voice signal transmitted from the electronic device; and
when the user input transmitted from the control device comprises a second voice signal, transmitting the second voice signal to the electronic device.

10. The operation method of claim 8, wherein the sensed function comprises a messenger function of the electronic device, the displayed UI comprises a first message transmitted from the electronic device, and the user input transmitted from the control device comprises at least one of a second message and a voice signal corresponding to the second message, and
the method further comprises displaying the second message.

11. The operation method of claim 8, wherein the sensed function comprises a remote control function allowing the electronic device to remotely control a controlled device, and
the operation method further comprises transmitting a command for controlling the controlled device to the electronic device based on the user input transmitted from the control device.

12. The operation method of claim 8, further comprising:
sensing that the electronic device is a smart key capable of controlling a vehicle; and
transmitting, to the vehicle, a control command based on the user input transmitted from the control device, wherein the displayed UI comprises information about the vehicle.

13. The operation method of claim 8, further comprising:
sensing a touch input with respect to the displayed UI via a touch pad arranged on an upper end portion of the display apparatus; and
manipulating the function associated with the electronic device based on the user input and the touch input.

14. The operation method of claim 8, further comprising:
obtaining orientation information of the electronic device; and
determining a location of displaying the UI on a screen of the display apparatus or selecting the sensed functions, based on the orientation information.

15. A computer-readable recording medium having recorded thereon a program, which when executed by a computer, performs the method of claim 8.
